(19) United States
(12) Patent Application Publication
(10) Pub. No.: US 2008/0292887 A1
(43) Pub. Date: Nov. 27, 2008

(54) Conductive Multiwalled Carbon Nanotube/Polyethylene Oxide (PEO) Composite Films and Methods of Use

(76) Inventors: Hyonny Kim, La Jolla, CA (US); Myounggu Park, Ann Arbor, MI (US)

Correspondence Address: BOSE MCKINNEY & EVANS LLP, 111 MONUMENT CIRCLE, SUITE 2700, INDIANAPOLIS, IN, 46204, US

(21) Appl. No.: 11/857,855

(22) Filed: Sep. 19, 2007

Related U.S. Application Data
(60) Provisional application No. 60/826,588, filed on Sep. 22, 2006.

(51) Int. Cl. B32B 17/06; B05D 5/12; B32B 9/04; B32B 15/04; B32B 13/04

(52) U.S. Cl. 428/426; 427/122; 428/704; 428/457; 428/446

(57) ABSTRACT

A method for fabricating an electrically conductive composite structure is provided. The method comprises forming a mixture including carbon nanotubes, a polymeric compound, surfactant and water; introducing the mixture to a substrate; and evaporating water from the mixture to form a composite film on the substrate.

### RELATED APPLICATIONS

This application claims the benefit of U.S. Provisional Patent Application Ser. No. 60/826,588, filed Sep. 22, 2006, the complete disclosure of which is expressly incorporated herein by this reference.

### TECHNICAL FIELD

The present invention is related generally to carbon nanotube/polymer composite films, and more particularly to methods of using the intentional coagulation of dispersed carbon nanotubes (CNT) and polymers to fabricate conductive composite films, including the use of the fabricated conductive composite films as strain sensors.

### BACKGROUND OF THE INVENTION

After Iijima [1] reported helical graphitic microtubules called carbon nanotubes (CNTs) in 1991, research efforts related to this material have increased exponentially over the years [2]. Some of this interest stems from the beneficial properties exhibited by CNTs, such as their high Young's modulus, good thermal conductivity and density, as well as their high electrical conductivity properties. These properties are comparable to those exhibited by metals, particularly in terms of their excellent strength and flexibility. Because of their beneficial attributes, a large body of research has been conducted to determine ways to take advantage of CNT's outstanding properties.

In the fields of electrical engineering, computer science and biomedicine, the application of CNTs has generally been at a nano or micro-scale level (i.e., applications directed to the usage of a single CNT). In the area of CNT-reinforced composite fabrication, however, their application has been more on a macro-scale level. In this research area, the overall focus has primarily been on the deformation dependent electrical resistance change of a multiwalled carbon nanotube (MWCNT) layer. Moreover, global research objectives have focused on ways to: (i) understand how micro and nano-scale interactions of individual CNTs affect macro-scale electrical resistance change, (ii) fabricate CNT filled polymer materials for experimental measurement, (iii) demonstrate real applications for the CNT-filled polymer, such as strain sensors, and, (iv) develop models to describe such experiments.

One industry that may benefit from CNT technology is the transportation industry. More particularly, future transportation vehicles may adopt sensor/actuator embedded composite structures to enhance performance, as well as to monitor the health of the vehicle, thereby potentially reducing associated maintenance costs [67]. Such a composite structure is commonly referred to as a “smart” structure because of its capability to sense and respond to surrounding environmental conditions. One basic form of composite structure currently being pursued is a strain sensing composite structure. These embedded composite structures are being pursed as strain sensing systems because they allow static and dynamic responses to be measured without significant adverse effects to the host structure [68]. As such, a large body of research has been conducted to fabricate strain sensors based on carbon nanotubes, particularly because of their superior electrical properties.

Currently, research efforts have been focused on single carbon nanotube strain sensors, as opposed to carbon nanotube filled composites that are formulated with many nanotubes. For instance, while P. Dharap, et al [69] demonstrated that carbon nanotube filled polymer films can be used as strain sensors, their work [69] also demonstrated wide scatter for resistance change versus strain data. Thus, research efforts directed to the use of carbon nanotube composite films as strain sensors, as well as efforts to fabricate suitable composite films, are still in the early stages.

The present invention is intended to address one or more of the problems discussed above.

### SUMMARY OF THE INVENTION

The present teachings are generally related to methods for fabricating multi-walled carbon nanotubes (MWCNT)/polymer composite films by intentionally coagulating dispersed MWCNTs in a polymer mixture, as well as using such fabricated films as strain sensing devices. In one exemplary embodiment thereof, the present teachings are directed to a method for fabricating an electrically conductive composite film. The method comprises coagulating dispersed multi-walled carbon nanotubes in the presence of a polyethylene oxide polymer mixture to form a dispersed microstructure.

In another exemplary embodiment thereof, the present teachings are directed to a processing method using the intentional coagulation of dispersed MWCNTs and a polyethylene oxide (PEO) polymer mixture to fabricate an electrically conductive composite film. The microstructure of the fabricated MWCNT/PEO composite film is composted of MWCNTs, which are well dispersed in the PEO matrix. Such well-dispersed microstructures are useful for achieving high electrical conductivity.

According to another exemplary embodiment of the present teachings, a method for fabricating an electrically conductive composite structure is provided. The method comprises forming a mixture including carbon nanotubes, a polymeric compound, surfactant and water; introducing the mixture to a substrate; and evaporating water from the mixture to form a composite film on the substrate.

In yet another exemplary embodiment in accordance with the present teachings, a method for fabricating an electrically conductive composite structure is provided. The method comprises forming a first solution including multi-walled carbon nanotubes, surfactant and water; forming a second solution including water and a polymeric compound selected from at least one of water soluble polymer-like polyethylene oxide and polyvinyl alcohol; mixing the first and second solutions together to form a third solution; pouring the third solution into a casting frame or immersing at least a portion of a copper substrate in the third solution; and subjecting the third solution to an evaporation casting procedure, the evaporation casting procedure causing a composite film to remain on the bottom surface of the casting frame or the copper substrate after the water has evaporated from the third solution. According to this specific embodiment, the casting frame can be made of glass and its surface coated with a release spray so that the film can be easily peeled off. In addition, the casting frame can have a lid to adjust the evaporation speed of the water, as well as to produce suitable water vapor pressure inside the casting frame and thus causing no residual stress of the fabricated film.

In still another exemplary embodiment in accordance with the present teachings, an electrically conductive composite film for use as a strain sensor is provided. The electrically conductive composite film is formed by subjecting a substrate to an evaporation casting procedure. During the evaporation casting procedure, the substrate is immersed in a mixture comprising carbon nanotubes, a polymeric compound, surfactant and water.

In one exemplary embodiment in accordance with the present teachings, the percolation threshold of the formulated composite film is between about 0.14 and 0.28 vol. % of the MWCNTs. According to this specific embodiment, the experimentally determined percolation threshold value is very close to the lower limit of the excluded volume method predicted model and thus, the MWCNTs inside the matrix can be considered randomly distributed or isotropic. As such, the present exemplary methods take full advantage of the used MWCNTs because the percolation threshold is directly related to the geometry of the used MWCNTs.

According to further embodiments of the present teachings, the exemplary films can be pre-stretched to some amount and bonded onto the structure surface. According to these exemplary embodiments, the film can be made more sensitive to external strain—i.e., the strain sensitivity of the fabricated film can be increased dramatically by using pre-stretched composite film. Moreover, due to the low melting and glass transition temperatures of the exemplary MWCNT/PEO composite films, the composite films can remain ductile at very low temperatures (e.g., near liquid nitrogen). As such, the composite films have a potential usage as strain sensors in extremely cold environments.

### BRIEF DESCRIPTION OF THE DRAWINGS

This application contains at least one drawing executed in color. Copies of this patent or patent application publication with color drawing(s) will be provided by the Patent Office upon request and payment of the necessary fee.

The above-mentioned aspects of the present invention and the manner of obtaining them will become more apparent and the invention itself will be better understood by reference to the following description of the embodiments of the invention taken in conjunction with the accompanying drawings, wherein:

FIGS. 1a-1c depict chirality arrangements of exemplary single walled carbon nanotubes in accordance with the present teachings;

FIG. 2 depicts an As-Fabricated MWCNT layer on a Cu substrate in accordance with the present teachings;

FIGS. 3a-3d depict exemplary MWCNTs grown on machining grooves of a copper surface as viewed using field emission scanning electron microscopy;

FIGS. 4a-4b depict atomic force microscope (AFM) images of a MWCNT layer on a groove in accordance with the present teachings;

FIG. 5 depicts a schematic MWCNT testing setup in accordance with the present teachings;

FIG. 6 depicts a graphical representation of the contact resistance of a bare Cu—Cu interface as a function of probe tip position in accordance with the present teachings;

FIG. 7 depicts a graphical representation of the contact force of a bare Cu—Cu interface as a function of probe tip position in accordance with the present teachings;

FIG. 8 depicts a graphical representation of the contact resistance of Cu-MWCNT-Cu interface as a function of probe tip in accordance with the present teachings;

FIG. 9 depicts a graphical representation of the contact force of Cu-MWCNT-Cu interface as a function of probe tip position in accordance with the present teachings;

FIG. 10 depicts a graphical representation of a comparison of contact resistance between a bare Cu—Cu interface and a Cu-MWCNT-Cu interface in accordance with the present teachings;

FIG. 11 depicts electrical conduction of an exemplary contact surface in accordance with the present teachings;

FIG. 12a depicts contact resistance reduction by a bare Cu—CU contact in accordance with the present teachings;

FIG. 12b depicts contact resistance reduction by parallel contacts created by MWCNTs in accordance with the present teachings;

FIG. 13 depicts an electrical junction of two MWCNT contact surfaces in accordance with the present teachings;

FIGS. 14a and 14b depict stacking sequences of MWCNT contact surfaces in accordance with the present teachings;

FIG. 15 depicts the aggregation of MWCNTs due to van der Waals force in accordance with the present teachings;

FIG. 16 depicts an exemplary MWCNT/Polymer composite film fabrication procedure in accordance with the present teachings;

FIG. 17 depicts an exemplary voltage divider circuit process in accordance with the present teachings;

FIG. 18 depicts a detailed view of a MWCNT/Polymer composite region in accordance with the present teachings;

FIG. 19 depicts a two point direct current resistance measurement setup in accordance with the present teachings;

FIG. 20 depicts an exemplary strain sensing test setup in accordance with the present teachings;

FIG. 21 depicts a detailed view of a ‘free end’ bonding scheme in accordance with the present teachings;

FIG. 22 depicts an As-Fabricated MWCNT/Polyvinyl acetate composite film on a Cu substrate in accordance with the present teachings;

FIGS. 23a and 23b depict an exemplary MWCNT/Polyvinyl acetate composite film on a Cu substrate in accordance with the present teachings;

FIG. 24 depicts an As-Fabricated free standing MWCNT/PVA composite film in accordance with the present teachings;

FIGS. 25a and 25b depict an exemplary MWCNT/PVA composite film in accordance with the present teachings;

FIGS. 26a and 26n depict cross-sectional morphologies showing a MWCNT distribution in accordance with the present teachings;

FIG. 27 depicts an As-Fabricated free standing MWCNT/PEO composite film in accordance with the present teachings;

FIGS. 28a and 28b depict a MWCNT/PVA composite film in accordance with the present teachings;

FIG. 29 depicts a graphical representation of the resistivities of MWCNT/Polymer composite films in accordance with the present teachings;

FIG. 30 depicts a graphical representation of electrical conductivity vs. MWCNT volume fraction in accordance with the present teachings;

FIG. 31 depicts a graphical representation of resistance change vs. strain in accordance with the present teachings;

FIG. 32 depicts a graphical representation of resistance change vs. strain (MWCNT 2 wt %) in accordance with the present teachings;

FIG. 33 depicts a graphical representation of resistance change vs. strain (MWCNT 5 wt %) in accordance with the present teachings;

FIG. 34 depicts a graphical representation of resistance change based on a compaction model in accordance with the present teachings;

FIG. 35 depicts a MWCNT/Polymer composite film-casting mold in accordance with the present teachings; and

FIG. 36 depicts an exemplary glass film-casting mold in accordance with the present teachings.

Corresponding reference characters indicate corresponding parts throughout the several views.

### DETAILED DESCRIPTION

The embodiments of the present teachings described below are not intended to be exhaustive or to limit the teachings to the precise forms disclosed in the following detailed description. Rather, the embodiments are chosen and described so that others skilled in the art may appreciate and understand the principles and practices of the present teachings.

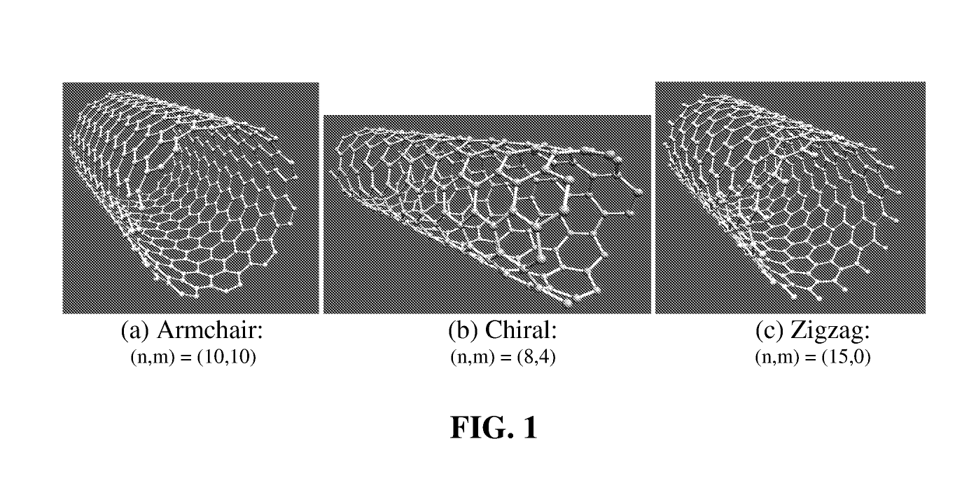

Exemplary CNTs in accordance with the present invention are essentially seamless cylindrical rolled-up graphene sheets. As used herein, chirality refers to a CNTs graphene sheet structure, including the strong affects of their electrical and thermal properties [3-12]. As is generally known within the art, CNTs can be described by their chiral vectors (n, m), which define the atomic structure of a carbon nanotube and determine its chirality or twist. Exemplary illustrations depicting the chirality of three single walled CNTs are shown in FIGS. 1a-1c, where FIG. 1a depicts an Armchair CNT having n and m values of 10 and 10, respectively; FIG. 1b depicts a Chiral CNT having n and m values of 8 and 4, respectively; and FIG. 1c depicts a Zigzag CNT having n and m values of 15 and 0, respectively. Moreover, Table 1 below summarizes documented electrical, mechanical, and thermal properties of exemplary CNTs disclosed herein. Note that the current density, Young's modulus and thermal conductivity of CNTs are the highest among known materials. In addition, it should be appreciated and understood herein that these CNTs can be either metallic or semi-conducting in their electrical conductivity, particularly due to chirality variation.

TABLE 1
Properties of Carbon Nanotubes

| Properties | Values | Reference |
|---|---|---|
| Electrical Resistivity | 10⁻⁶-10⁻⁴ Ω-cm | [3], [4] |
| Current Density | 10⁹-10¹⁰ A/cm² | [5] |
| Young's Modulus | 1-2 TPa | [6], [7] |
| Tensile Strength | 40-50 GPa | [8], [9] |
| Thermal Conductivity | 2000-4000 W/mK | [10], [11], [12] |

Turning now to the effects of MWCNTs on electrical contact resistance, MWCNT layers under compressive deformation were studied and observed. Each graphene layer within the MWCNT exhibits either metallic or semi-conducting electrical properties, depending on the diameter and the chirality. Metallic MWCNTs typically have a wide range of resistance values ranging from 478Ω to 29 KΩ for instance [13]. Some researchers have reported on MWCNT arrays to improve the thermal and electrical interface transport properties [14, 15] of MWCNTs. For instance, Tong [15] investigated a vertically aligned CNT film on a silicon wafer substrate and found that their minimum resistance values varied from 1Ω to 20Ω. However, Tong [15] did not specifically address possible contact resistance reduction mechanisms. The present teachings, in contrast, investigate contact resistance change and mechanisms using a non-directionally grown MWCNT layer.

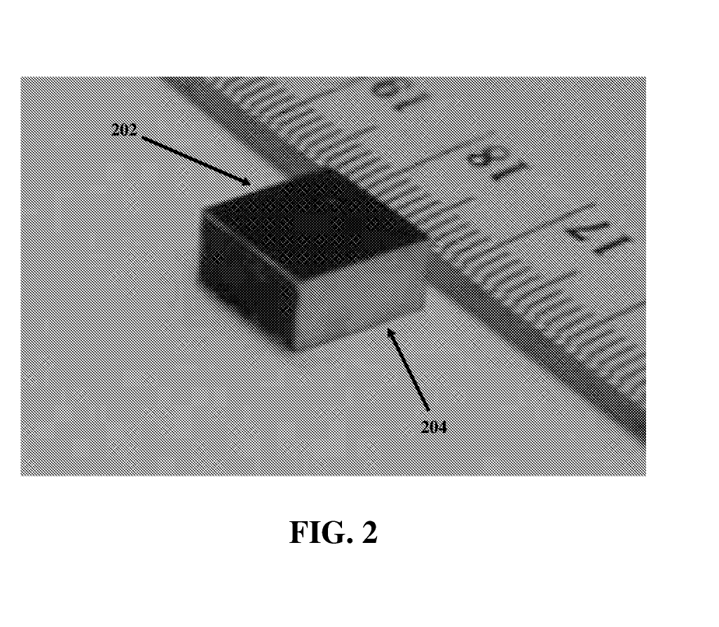

In one experiment in accordance with the present invention, a MWCNT layer was grown on a copper substrate. According to this exemplary experiment, a mechanically surface-ground (46 grit wheel) copper plate (Alloy 110; Electrolytic Tough Pitch Copper) was used as a substrate onto which MWCNTs were grown. The plate dimensions were 10×10×0.5 mm. It should be noted that the resistivity of copper was low at 1.47×10⁻⁸ Ω-m [16], which is an attribute that is desired for accurately measuring the electrical resistance of MWCNT layers. Three metal layers of Ti, Al, and Ni (thickness: 30 nm, 10 nm, and 6 nm, respectively) were deposited onto the copper substrate using electron-beam evaporation. The Ti layer promoted adhesion of the MWCNT to the copper substrate, while the Al layer acted as a “buffer” layer and enhanced the CNT growth with the Ni catalyst [14, 17, 18], which provided seed sites for the CNT growth [19, 20]. The CNTs were grown on the substrate surface by a microwave plasma enhanced chemical vapor deposition (PECVD) process [14]. The feed gases were H₂ and CH₄, with the flow rates of the H₂ and CH₄ being 72 and 8 sccm, respectively. The H₂ plasma was maintained under a microwave power of 150 W and the process temperature was kept at 800° C. for a growth time of 20 minutes. An as-fabricated MWCNT layer 202 grown on the Cu substrate 204 in accordance with this exemplary process is shown in FIG. 2. It is noted that the black surface that is visible in the photo represents the MWCNT layer 202 on top of the Cu substrate 204.

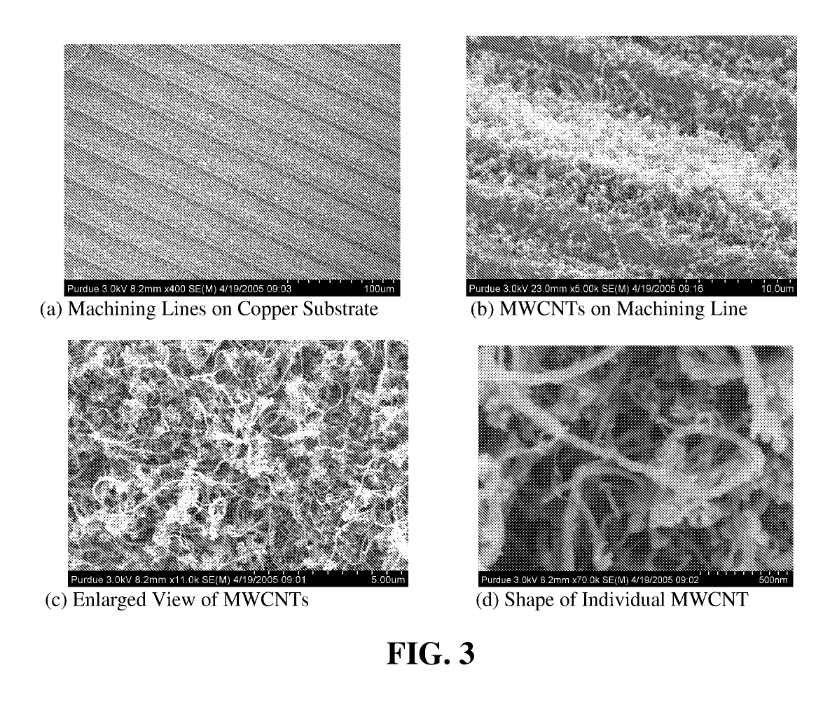

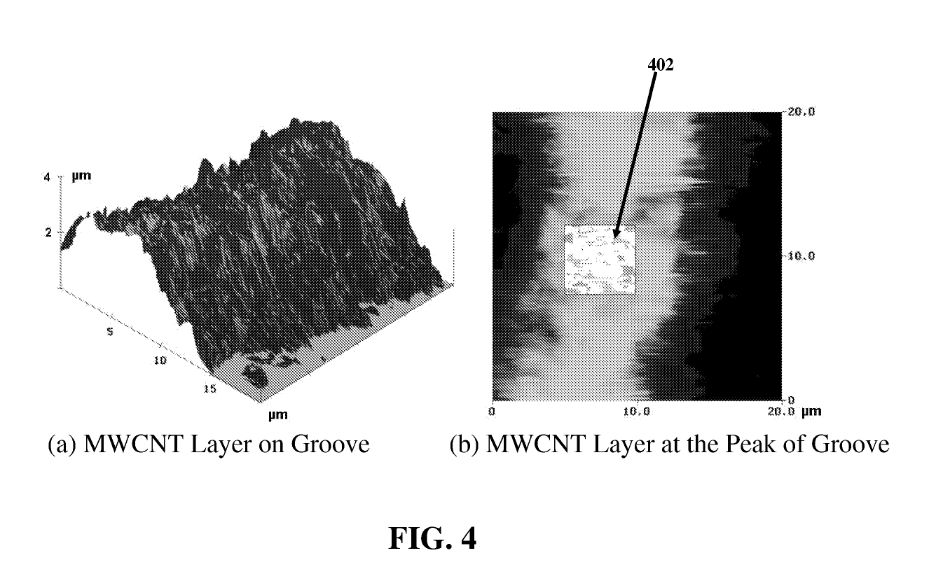

To characterize the MWCNT layer 202, the sample surface was observed using field emission scanning electron microscopy (FE-SEM). It was observed that the MWCNTs grew on the machining grooves of the copper surface (see FIGS. 3a and 3b), and the overall CNT layer did not show any preferred direction (see FIG. 3c). The individual CNTs had a bamboo-like structure, which is a typical feature of relatively large diameter MWCNTs (FIG. 3d). The surface height profile and roughness of the MWCNT layer was obtained using a Veeco DI 3100 atomic force microscope (AFM). The typical three-dimensional (3D) groove shape of the MWCNTs was then measured by the AFM (see FIGS. 4a-b). The mean roughness value of the MWCNT layer at a peak location of the machining groove was found to be 122 nm (see the square region 402 in FIG. 4b). In comparison, it is noted that the surface roughness of a silicon on insulation (SOI) wafer is about 1 to 2 nm [21], while the surface roughness of a polished metal surface is about 800 nm. Thus, the MWCNT layer is relatively rougher than a typical SOI wafer, but smoother than a mechanically polished metal. The height profile of the MWCNT layer (FIG. 4a) indicates that the surface also has some sharp peak features.

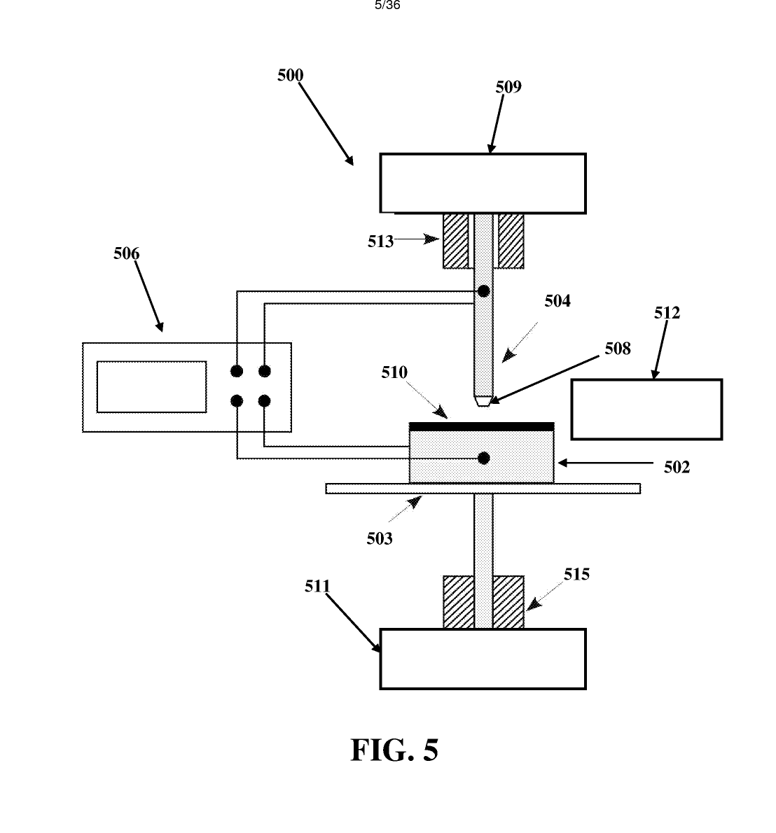

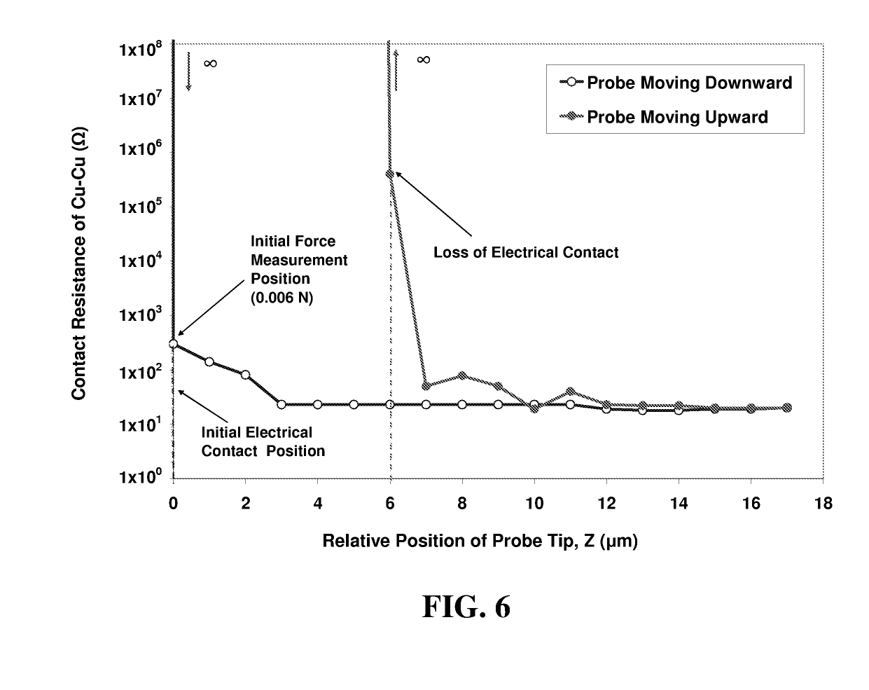

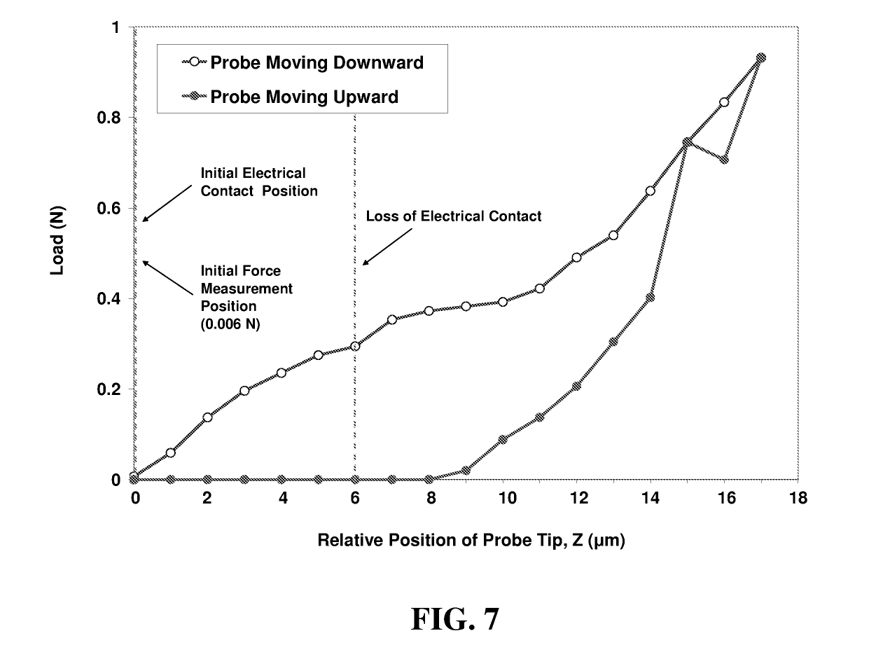

Turning now to FIG. 5, a schematic of an exemplary test setup 500 in accordance with the present teachings is shown. According to this exemplary setup, the MWCNT-enhanced Cu substrate 502 on a glass plate 503 was subjected to compressive loading using a Cu probe 504, and the electrical resistance change was monitored by a multimeter 506 (Hewlett Packard 3478A). To measure precisely small resistance changes, a four-point multimeter measurement scheme was adopted. Moreover, Cu was chosen as the probe material to match the properties of the Cu substrate 502. As the probe tip area 508 (0.31 mm²) was much smaller in dimension than the substrate 502, multiple measurements could be made with each specimen by changing the probing location. A small-scale mechanical testing machine 509 (i.e., Bose Endura ELF 3200) was used to control or actuate the probe 504 displacement and to measure the interaction force between the probe 504 and the MWCNT-enhanced Cu substrate surface 510 with a load cell 511 having a upper grip with insulation 513 and a lower grip 515. The position of the probe tip 508 was adjusted toward the sample surface 510 while monitoring the position of the probe tip 508 through a CCD camera 512. Starting from a non-contacting position (infinite electrical resistance), the probe 504 was displaced downward slowly in 1.0 μm increments until a measurable electrical resistance was observed. This location was then set to be the initial position (Z=0 μm) of the probe 504, and the probe tip 508 was subsequently moved downward by 1.0 μm increments. At each step of displacement, contact resistance and force data were recorded. When the resistance displayed a trend close to a constant value, the probe descent was stopped. The probe 504 was then moved upward (reverse direction) in 1.0 μm increments while measuring the contact resistance and force until electrical contact was lost (infinite resistance). Turning now to FIG. 6, the measured electrical resistance of a Cu probe contacting a bare Cu surface (i.e., a surface not having a MWCNT layer) is shown and plotted as a function of probe tip displacement. The first finite contact resistance measured was 300Ω, which corresponded to an initial contact force of 0.006 N. This probe position was regarded as the initial position (Z=0 μm). As shown in FIG. 7, while the probe moved downward, the resistance decreased, yet the force increased. After the Cu probe passed Z=3 μm, however, the resistance remained constant at a value of 20Ω, regardless of the contact force. The downward movement of the Cu probe was stopped at Z=17 μm, and the probe was then moved upward in 1 μm increments while the resistance and force data was collected as described above. The resistance did not change significantly until the probe moved upward to Z=7 μm. At Z=6 μm, the resistance increased to 0.4 MΩ and thereafter indicated infinite resistance. It should be noted that electrical contact was lost before the probe reached the initial position (Z=0 μm).

The testing procedure indicated that the contact force during loading (i.e., while the probe moved downward) and unloading (i.e., while the probe moved upward) did not match the same path. This is indicated in the force-displacement measurements shown in FIG. 7. Contact force initially shows a linear tendency (initial stiffness: 0.067×10⁶ N/m) and then non-linear behavior as the probe moved downward. Lower force values at corresponding Z positions with non-linear behavior were observed as the probe moved upward.

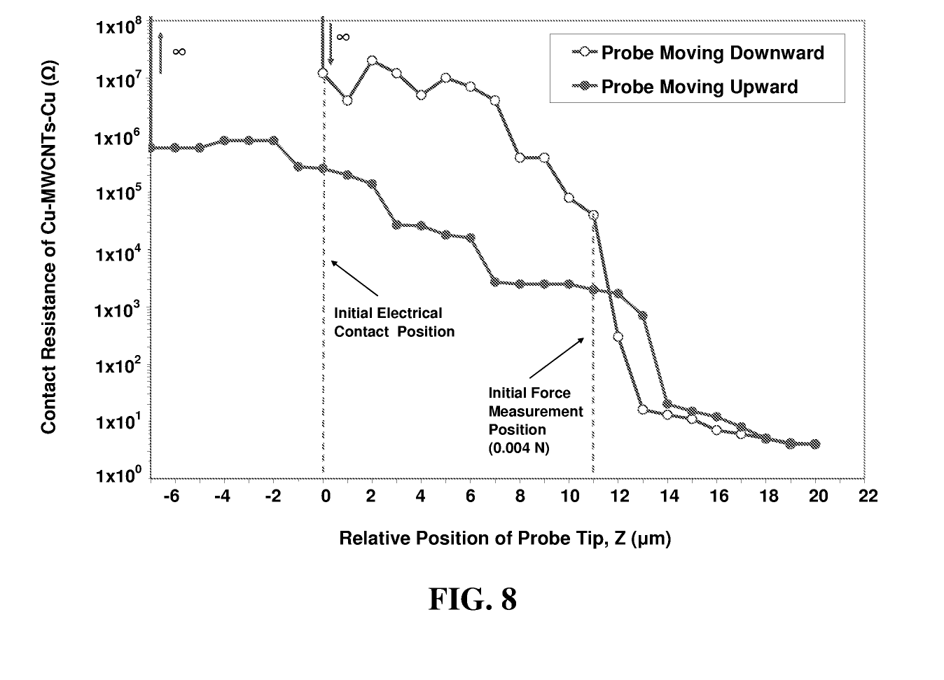

A typical contact resistance change between the Cu probe and the MWCNT enhanced Cu substrate as a function of position is shown in FIG. 8. As the probe was lowered, the resistance decreased. The resistance ranged from a maximum value of 10⁸Ω to a minimum value of 4Ω. The position corresponding to the first finite resistance value was identified as the initial electrical contact position (Z=0 μm). The resistance did not change significantly until the probe moved downward past Z=7 μm. At Z=11 μm, the first measurable reaction force was observed. The electrical resistance then reduced significantly to a steady value of 4Ω with increased probe movement. It is noted that between the initial position (Z=0 μm) and Z=11 μm, there was no measurable force but electrical contact was maintained (finite resistance was measured). Resistance measured while the probe moved upward (reverse process) for the first several steps (from Z=20 μm to Z=14 μm) showed similar or slightly higher values at corresponding positions of the downward measurement. However, the resistance did not increase to an infinite value when the probe passed the position from where contact force between two surfaces dropped to zero (Z=13 μm). Electrical contact was maintained even past the initial position Z=0 μm up to Z=−7 μm. This trend was opposite to that observed for the bare Cu—Cu contact described above. In addition, step-like features of resistance change were evident during both downward and upward movements of the probe. These features were attributed to clumping between MWCNTs due to van der Waals forces.

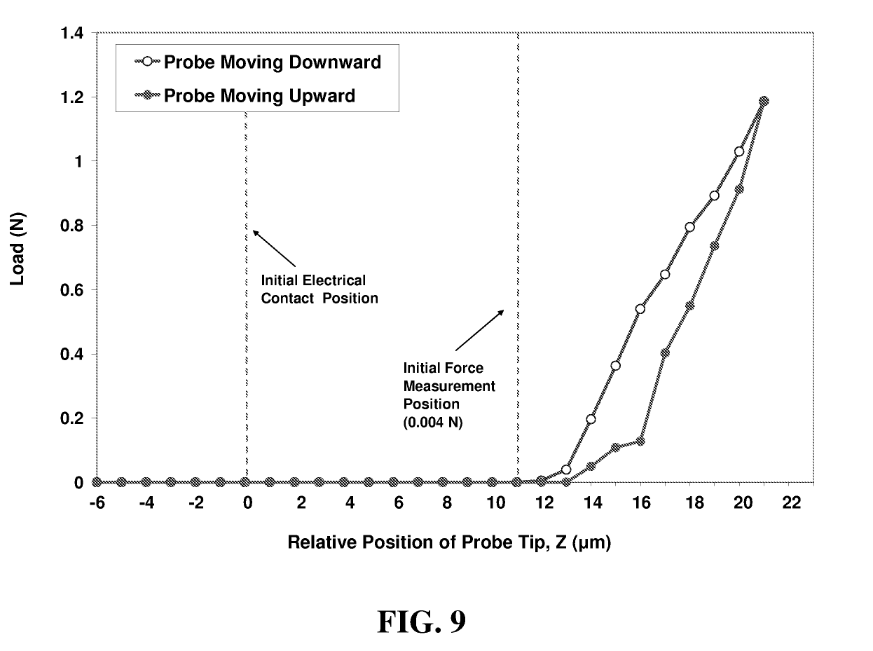

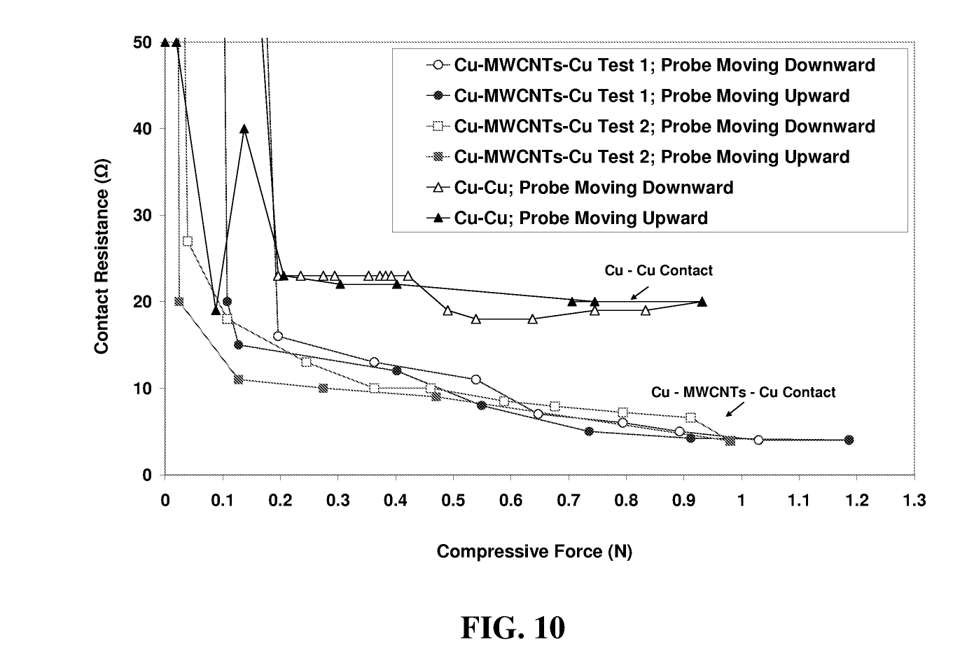

In FIG. 9, contact force was plotted as a function of probe tip displacement. Here, changes in force were found to be more linear than those shown in the Cu—Cu contact control case of FIG. 7. The average stiffness during downward movement (0.173×10⁶ N/m) was found to be over several times higher than the initial stiffness of the bare Cu—Cu contact (0.067×10⁶ N/m). It is also interesting to note that after the probe registered a measurable force, trends of contact resistance versus force (two Cu-MWCNT-Cu tests) were found to overlap closely with one another for the different tests conducted (see FIG. 10).

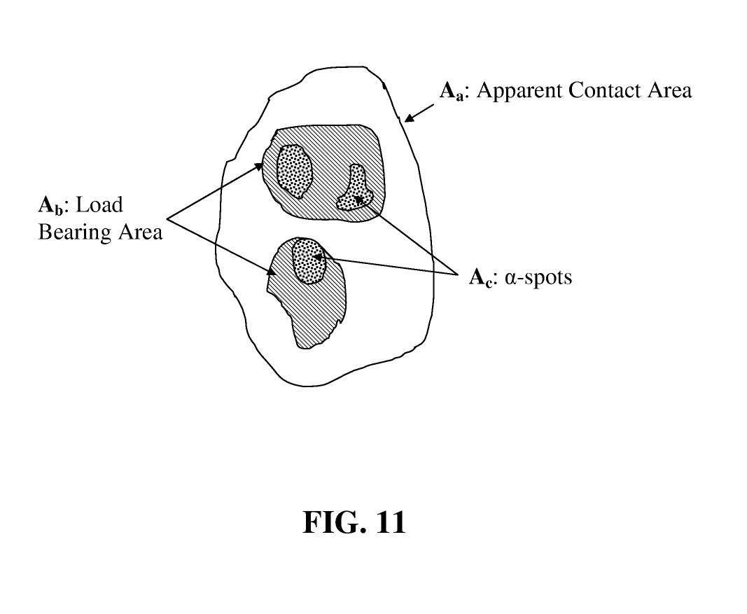

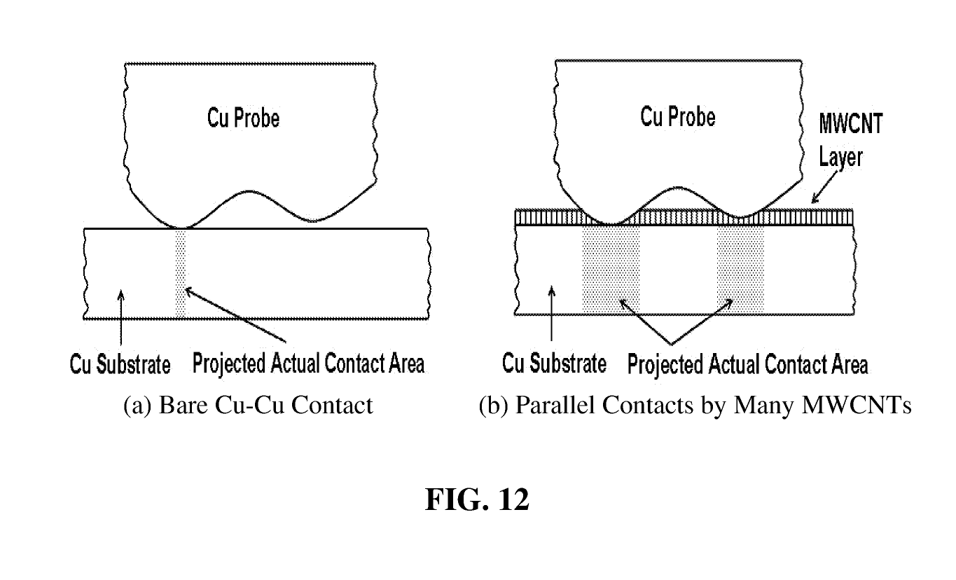

For the same apparent contact area, the Cu-MWCNT-Cu interface showed a minimum resistance of 4Ω, while the Cu—Cu interface showed a minimum resistance of 20Ω. Therefore, an 80% reduction was observed. It is noted that only a portion of the apparent contact surface, indicated as A_{c} (α-spots) in FIG. 11, participates in electrical conduction [22]. In the case of the Cu-MWCNT-Cu contact, CNTs significantly increase the size of A_{c} (α-spots). It can be simplified conceptually as shown in FIGS. 12a and 12b. The gap between the two contacting members is filled with MWCNTs, thereby increasing the contact area (see FIG. 12b) via numerous parallel electrical contact paths. If the load bearing area is increased, the force will increase accordingly. As such, it can be concluded that the MWCNT layer is also effective in enlarging the load bearing area, and higher contact stiffness values will be measured.

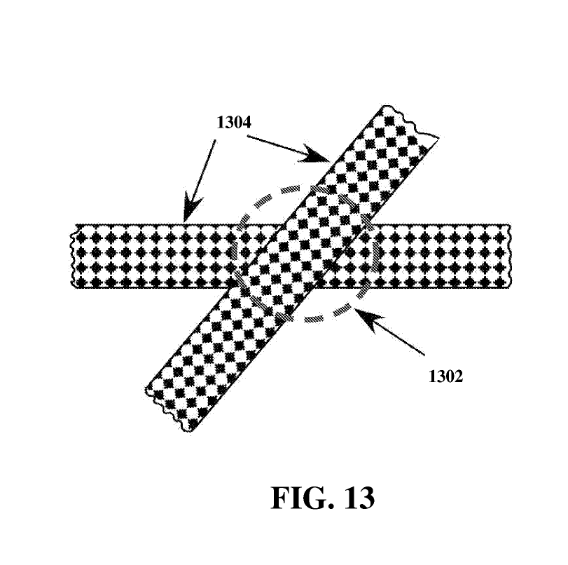

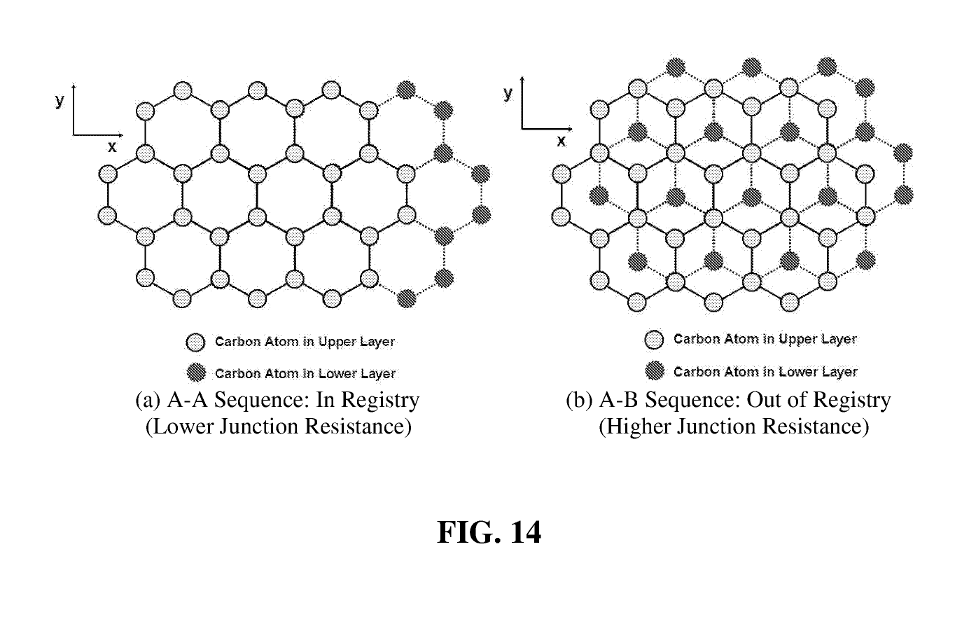

Resistance reduction is also possible though electrical junctions 1302 made between CNTs 1304, such as is illustrated in FIG. 13 for instance. The non-directionally grown MWCNTs on the substrate's surface (see FIGS. 3a-3d) create electrical junctions 1302 among adjacent CNTs to reduce the contact resistance. Other researchers suggest that contact resistance varies widely depending upon the relative orientation of two CNT surfaces (see FIGS. 14a and 14b) [23, 24]. Therefore, it is believed that the ensemble of the numerous contacts and junctions created during the probe movement dictate the macroscopic contact resistance.

Due to their molecular structures, interactions among CNTs are dominated by van der Waals forces that tend to bundle individual CNTs [25, 26]. For instance, as shown in FIG. 8, MWCNT-enhanced Cu surfaces exhibited step-like resistance changes and maintained electrical contact over a larger distance than bare Cu—Cu contact, particularly during movement of the contacting probe away from the surface. It is suggested that this is due to uprooted MWCNTs bridging the probe and substrate via van der Waals forces, thereby maintaining electrical contact during probe movement.

Experimental measurements have shown that a MWCNT layer between Cu—Cu surfaces reduces electrical contact resistance by 80%. It is thus an excellent interfacial material to reduce electrical resistance. Also, the MWCNT-enhanced surface showed a finite slope of electrical resistance as a function of contact force, thereby making possible the use of this arrangement as a small-scale force or pressure sensor (see below for a more detailed discussion). While as-grown MWCNT layers have some positive benefits, they also have some limitations. For instance, due to their weak bonding to the substrate, MWCNTs are easily separated from the substrate surface. As such, in some applications, repeatability and reliability cannot be guaranteed. Furthermore, the fabrication of a MWCNT layer onto substrates of interest using Plasma Enhanced Chemical Vapor Deposition (PECVD) is typically an impractical manufacturing choice, primarily because of the high costs and low yield (i.e., typically it has a less than 10% yield success rate) associated with this technique. Therefore, MWCNT filled polymer layers are being considered. The fabrication and characterization of MWCNT/polymer composite film are detailed below.

CNT film composites have great potential for many different applications, such as, for instance, strain sensors, transparent conductive films, and filtering membranes [27-32]. Methods frequently used to fabricate CNT film include filtering techniques [27, 29 and 30], in-situ polymerization methods [28], layer-by-layer (LbL) methods [33] and evaporation methods [34 and 35]. Among these methods, evaporation methods can be performed without the use of sophisticated equipment. This method originated from latex polymerization [36-39], which is a widely used industry technique. Moreover, a significant amount of research has been conducted on the fabrication of MWCNT/Polymer composites [40-43]. However, researchers tend to use various methods for fabricating MWCNT/polymer composites, and often, these methods are dictated by process parameters. Moreover, depending on the parameters involved, the CNT-filled polymer film may have various inner and surface structures. Thus, it is indispensable to establish correct relationships between MWCNT/polymer composites and parameters in such fabrication methods.

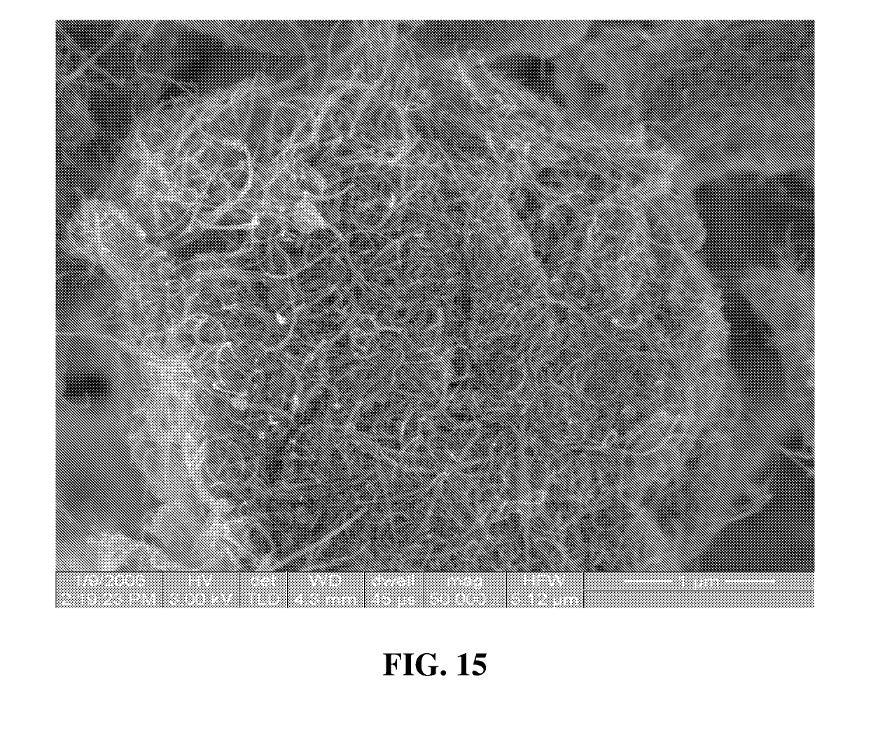

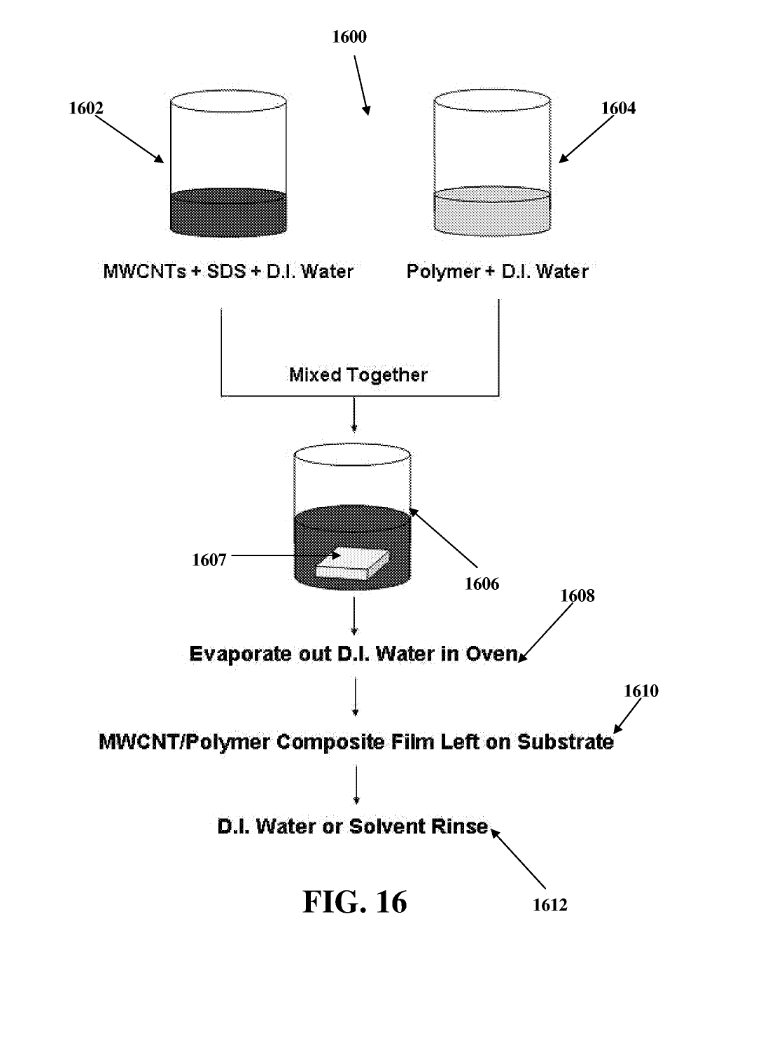

In another exemplary experiment in accordance with the present teachings, compaction based in situ polymerization for the fabrication of a MWCNT/PEO (polyethylene oxide) composite film was conducted. According to this experiment, specimens were created using commercially available MWCNT purchased from NANO LAB. The MWCNT had a length of between 1-5 μm, a diameter of 15±5 nm and a purity of 95%. As shown in FIG. 15, the MWCNTs tended to aggregate due to van der Waals interactions. As MWCNTs are hydrophobic, a sodium dodecyl sulfate (SDS) C₁₂H₂₅NaO₄S surfactant (purchased from bioworld) was used to lower the surface tension between the MWCNT and water [44, 45]. In FIG. 16, an exemplary processing procedure 1600 is schematically illustrated. More particularly, an SDS solution (1 wt %) was prepared using a magnetic stirrer. MWCNTs were then mixed with surfactant solution by an ultrasonicator (Misonix Sonicator® 3000) for 10 minutes (see reference numeral 1602). Polyethylene oxide (PEO) and polyvinyl alcohol were used as the matrix material. Each polymer was dispersed in D.I. water by magnetic stirrer for 10 min (see reference numeral 1604). The dilute MWCNT and polymer colloidal solutions were then combined together and mixed by ultrasonication for one hour (see reference numeral 1606). This solution 1606 was then introduced to a substrate by either being poured into a casting frame having a surface coated with a release spray or by immersing at least a portion of the substrate in the mixture solution. Evaporation of water was achieved in an oven at 90° C. (see reference numeral 1608), which is above the melting temperature of the polymeric compound (e.g., PEO), and the D.I. water was evaporated until a MWCNT/polymer composite film was formed on the metallic substrate (e.g., copper) or the release film of the casting frame 1607 (see reference numeral 1610). Following cool-down, a D.I. water rinse of the composite film was conducted (see reference numeral 1612) to remove residual surfactant on the MWCNT film surface.

While the exemplary embodiments of the present invention are primarily directed to copper substrates, those of skill in the art should understand and appreciate herein that other substrates can also be used in accordance with the present teachings to support the fabrication of the disclosed composite films. Such exemplary substrates include, but are not limited to, metallic substrates, such as copper, as well as silicon wafers and glass plates. As such, the present teachings are not intended to be limited to the embodiments disclosed herein, but should instead encompass other variations within the related art.

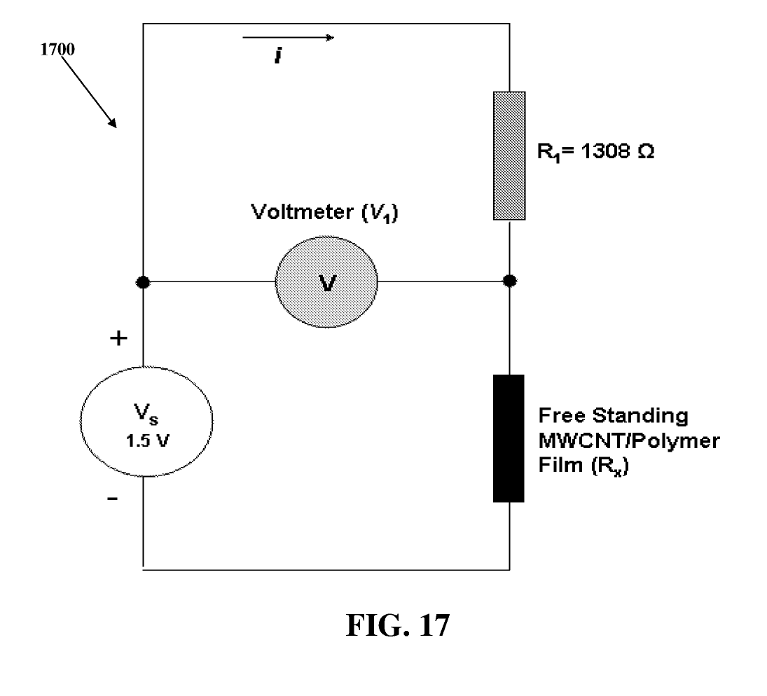

Direct current (DC) resistance measurement of the MWCNT/polymer composite film was then conducted using a voltage divider circuit 1700 [46], as shown in FIG. 17. The role of the voltage divider circuit 1700 is to lower power consumption of the MWCNT/polymer composite film sample, thereby avoiding heat damage [47]. By measuring v₁ and v₂, the resistance of the MWCNT/polymer composite film (Rₓ) can be calculated by the following formula.

$${R}_{x} = {R}_{1} ( \frac{{v}_{1}}{{v}_{2}} - 1 ) , wherein {R}_{1} = 1308 Ω . \qquad [ 1 ]$$

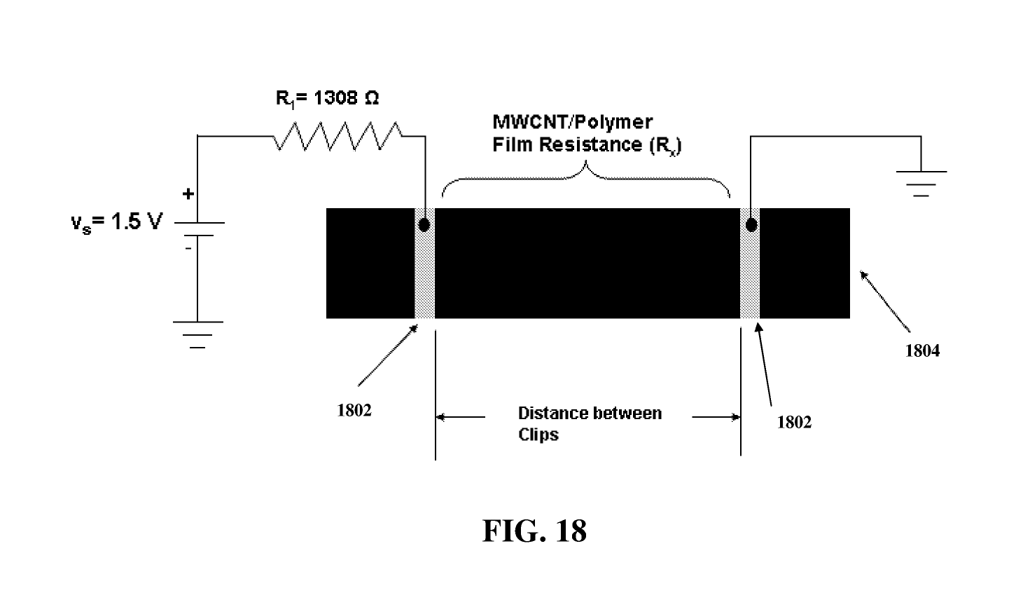

The detailed view of the MWCNT/polymer composite film region is shown in FIG. 18. Smooth jaw alligator clips 1802 were used to connect the MWCNT/polymer composite film 1804 to the circuit. Four MWCNT/polymer composite film samples were measured and their dimensions are shown in Table 2.

TABLE 2
Dimensions of MWCNT/Polymer Composite Sample

| | |
|---|---|
| Composite Film | Dimensions of sample (mm) |

| | | |
|---|---|---|
| MWCNT/PVA | Sample 1 | 0.19 × 21.30 × 4.0 |
| | Sample 2 | 0.14 × 2.65 × 4.64 |
| MWCNT/PEO | Sample 1 | 0.09 × 20.77 × 6.37 |
| | Sample 2 | 0.2 × 20.37 × 4.14 |

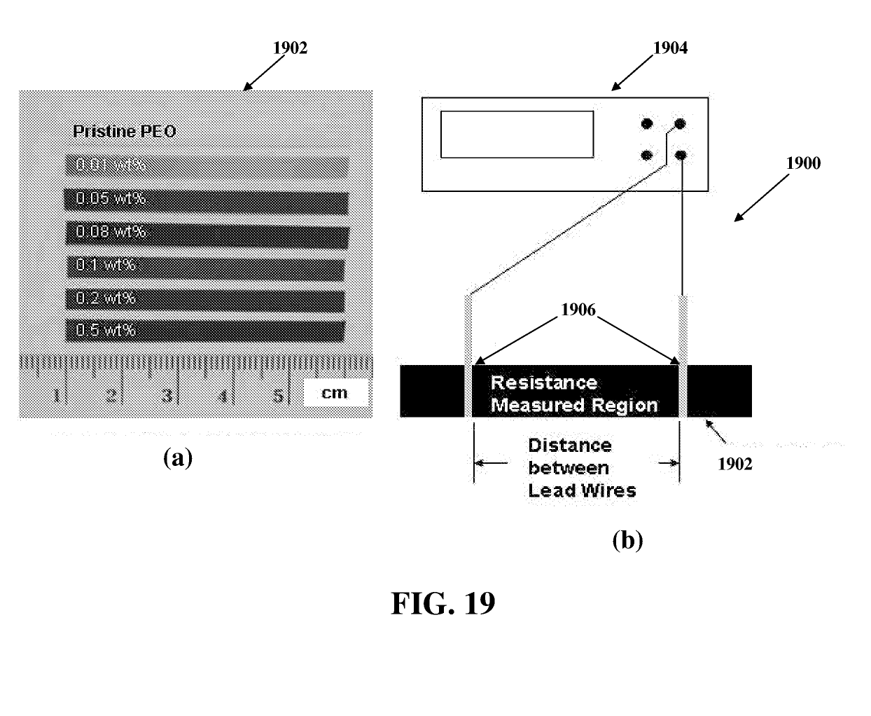

As shown in FIG. 19a, MWCNT/PEO composite films 1902 having different MWCNT contents (i.e., pristine PEO, 0.01 wt %, 0.05 wt %, 0.08 wt %, 0.1 wt %, 0.2 wt % and 0.5 wt %) were then fabricated. The dimensions of the prepared MWCNT/PEO composite films were 6×0.4 cm and had an average thickness of 0.14 mm. Direct current (DC) resistance measurements of the MWCNT/PEO composite film 1902 were conducted using a precision multimeter 1904 (Keithley 2000). The test setup 1900 is schematically depicted in FIG. 19b. Though the two-point measurement scheme includes the resistance of lead wires 1906 and contacts, this added resistance is negligible relative to the resistance range of the films being greater than 1 ohm [70]. To make a secure contact of the lead wires to the cross section of the sample, the lead wires were heated to 50° C. and then gently pressed onto the sample surface, thereby embedding into the cross-section.

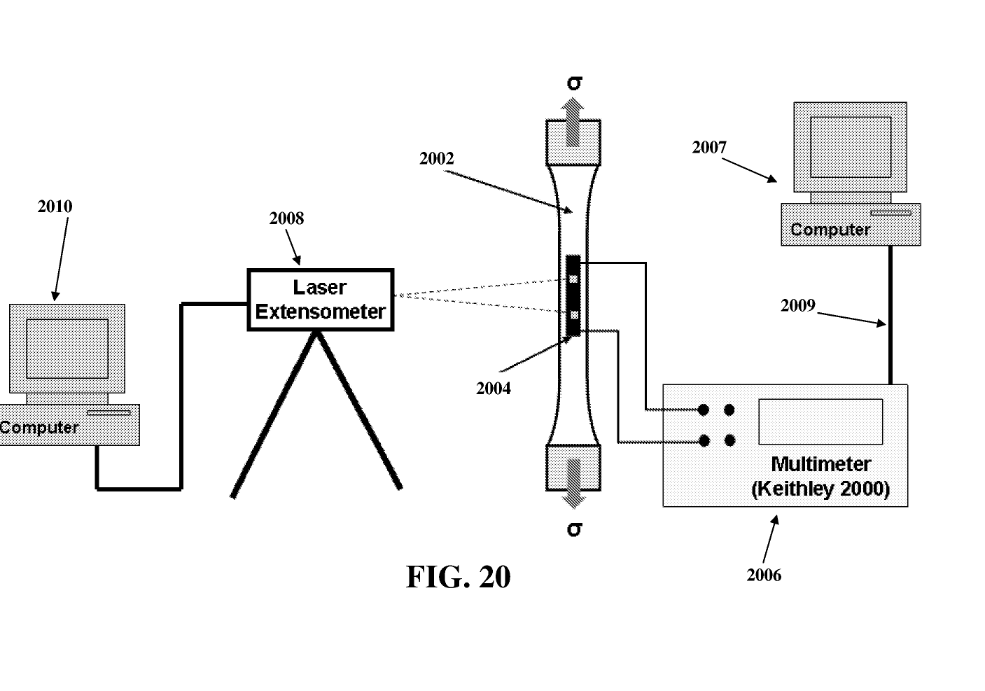

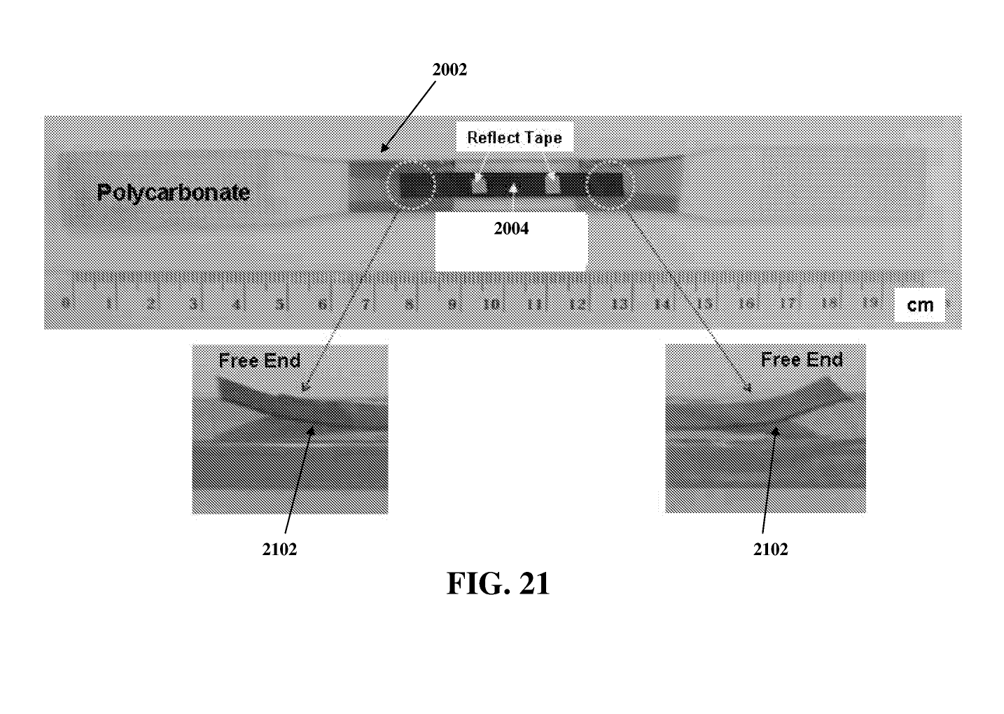

To test the strain sensing capability of the MWCNT/PEO composite film, a dogbone shaped polycarbonate plastic specimen 2002 was prepared and a strip of MWNT/PEO film 2004 (5 vol %) was bonded onto one surface as shown in FIG. 20. This specimen was tensile tested while the resistance change of the MWCNT/PEO composite film was recorded by the multimeter 2006 that was in turn connected to a computer 2007 via a Recommend Standard number 232 communication (RS-232 communication) 2009. As shown in FIG. 21, to make sure that the resistance change was induced only by the deformation of the composite film 2004, the end regions 2102 of the film were not bonded onto the dogbone specimen 2002 and the lead wires were then attached to these free end surfaces using the above-described method. The strain of the sample was then recorded by a laser extensometer 2008 (Electronics Instrument Research, Ltd Model LE-05) connected to a computer 2010.

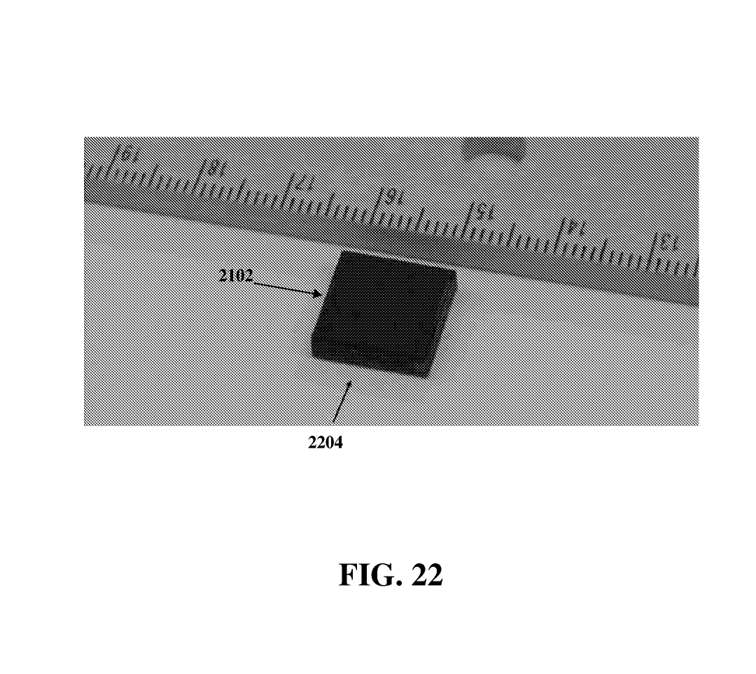

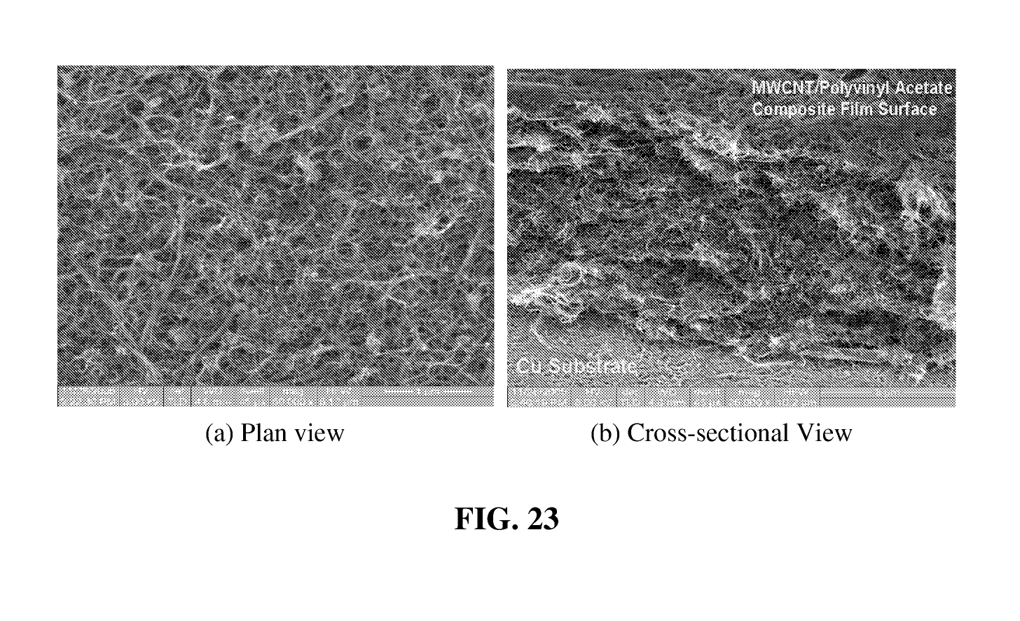

An as-fabricated MWCNT/polyvinyl acetate composite film 2202 bonded to a Cu substrate 2204 is shown in FIG. 22. The surface of the MWCNT film 2202 showed a dense and porous layer, which is mostly composed of MWCNTs (see FIGS. 23a and 23b). The cross section of the film also showed densely populated MWCNTs and a porous inner structure. The thickness was measured as 6.57 μm.

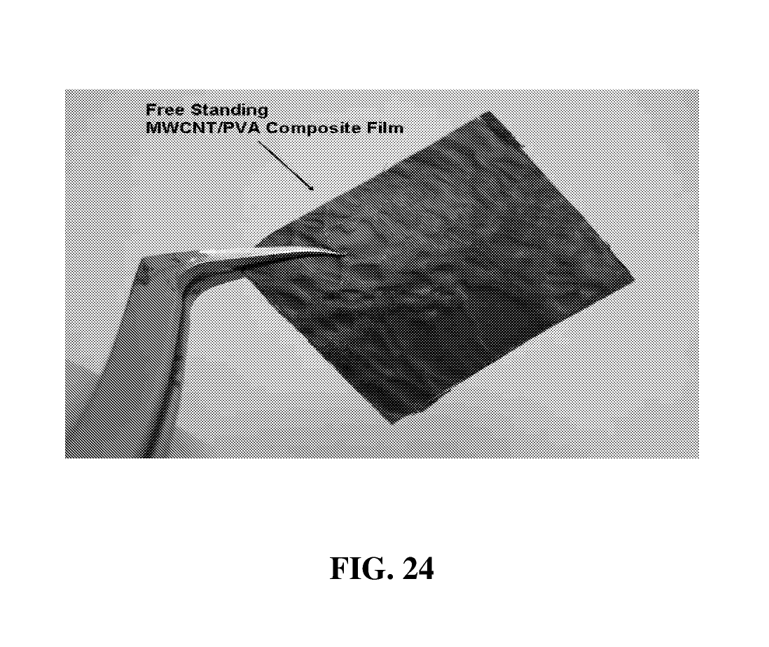

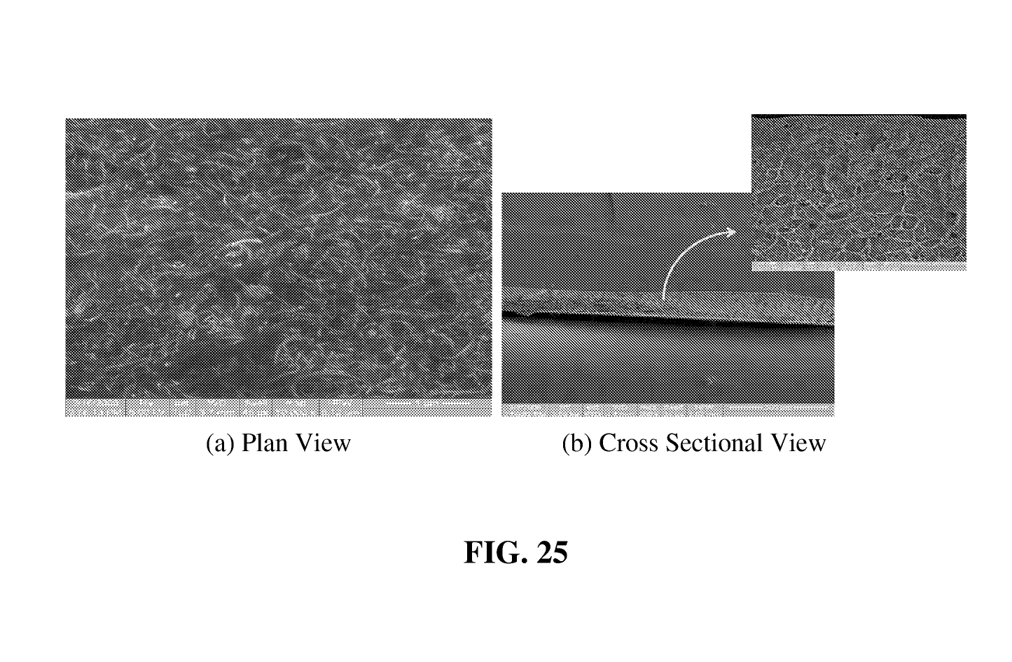

An as-fabricated freestanding MWCNT/PVA composite film is shown in FIG. 24. Here, the morphology visible on the cross-section of the MWCNT/PVA composite film showed granular shapes (see FIGS. 25a and 25b). In addition, it was found that the thickness of the sample was not uniform, but instead varied from 91.3 μm to 117.4 μm. For a PVA density of 1.3 g/cm³ for this 10-wt % MWCNT sample, the volume fraction of the MWCNT and PVA are calculated as 7.2% and 92.8%, respectively. For this volume fraction, the resistivity of the MWCNT/PVA composite film ranged from 7.6×10³ to 5×10⁴Ω-cm.

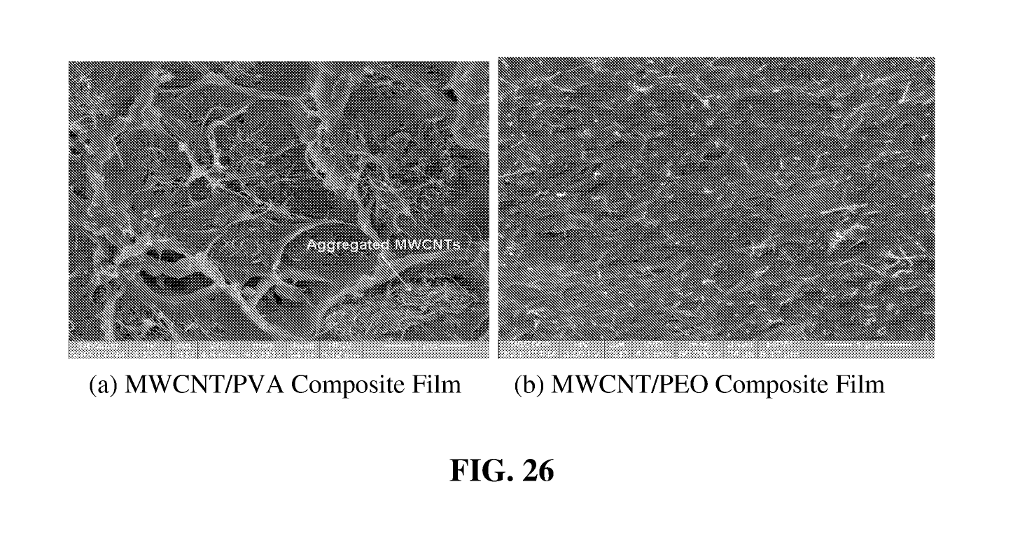

The resistivities of the MWCNT/PVA and MWCNT/PEO composite films differed greatly despite having identical loadings of the MWCNTs (i.e., 10 wt %). The resistivity of the MWCNT/PVA composite film ranged from 7.6×10³ to 5×10⁴ Ω-cm, while the resistivity of the MWCNT/PEO composite film ranged from 2 to 7 Ω-cm. Based on a theoretical prediction of the percolation threshold (see Table 3), both of these composite films are considered conductive. It is noted that the volume fraction of the MWCNT for the MWCNT/PVA composite films is 7.2% and 6.3% for the MWCNT/PEO composite film. However, only the MWCNT/PEO composite film was measured to be conductive. The explanation can be found in their microstructure (see FIGS. 26a and 26b). The MWCNT/PVA composite film's inner structure revealed that the MWCNT were severely aggregated as shown in FIG. 26a. Consequently, the MWCNTs were not effective as conductive fillers. As such, these results show that not only colloidal stability, but also the coagulation process, is very important in the morphology of the film.

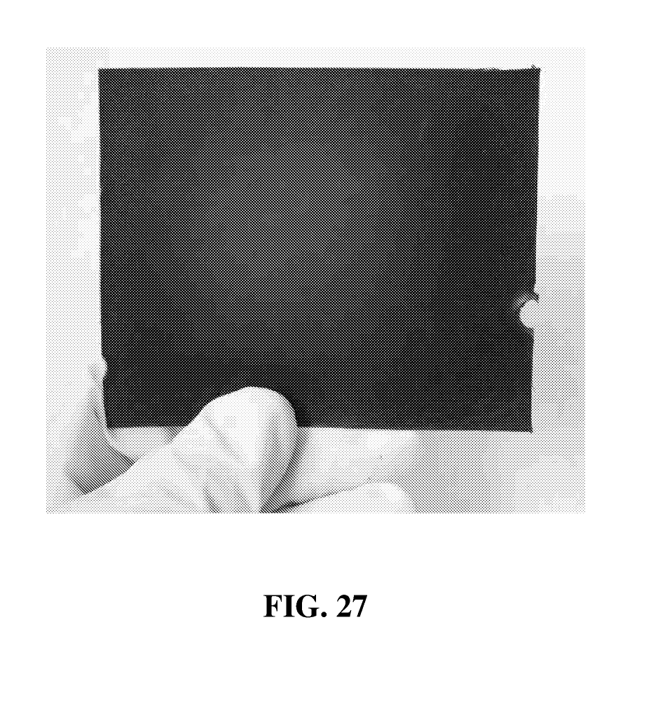

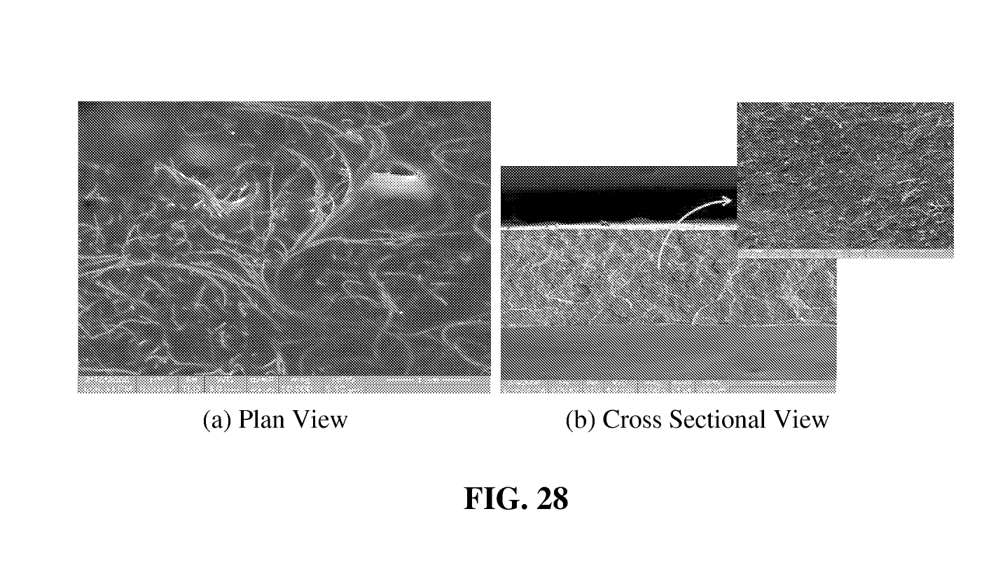

An as-fabricated freestanding MWCNT/PEO film is shown in FIG. 27. As is shown in FIGS. 28a and 28b, this film is non-porous and has a non-directionally dispersed MWCNT. To obtain cross sectional morphology (FIG. 28b), a small piece of the MWCNT/PEO film was dipped into liquid nitrogen for one minute and then immediately fractured upon removal. The MWCNTs were well distributed and had a MWCNT/PEO film thickness of 96.8 μm. Moreover, the density of the MWCNT was 1.8 g/cm³, while the density of the PEO was 1.13 g/cm³. The volume fraction of the 10-wt % MWCNT and the PEO were calculated to be 6.30% and 93.7%, respectively, and the electrical resistivity of the film was measured to range from 2 to 7 Ω-cm.

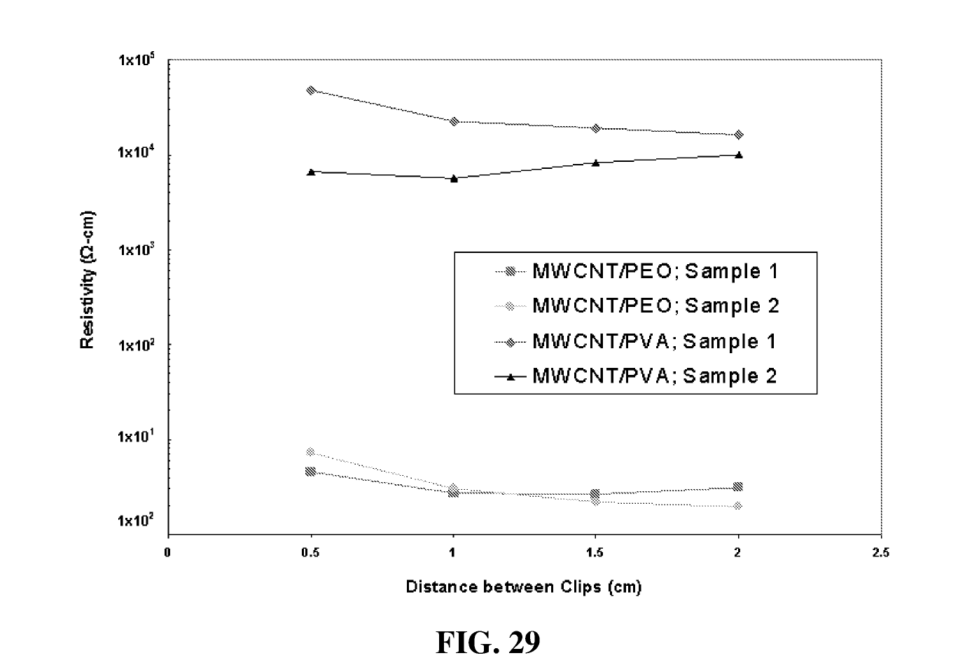

Resistance of four different samples (see Table 2) was measured. The resistivity change as a function of clip distance is shown in FIG. 29. The resistivity of the MWCNT/PVA composite film ranges from 7.6×10³ to 5×10⁴ Ω-cm, while the resistivity of the MWCNT/PEO composite film ranges from 2 to 7 Ω-cm. It was determined that the difference between these two MWCNT/polymer composite films may be attributed to the colloidal instability and polymer solidification process. For instance, neat PVA and PEO polymers (unfilled) are reported to have resistivity of 3.1×10⁷ to 3.8×10⁷ Ω-cm and 10¹³ to 10¹⁸ Ω-cm, respectively.
In terms of the present methods, the polymer and MWCNT colloids are coagulated intentionally through evaporation of the water [48]. As such, the stability and control of colloid particle coagulations are very important when producing a desired MWCNT/polymer composite film. According to theories developed by Derjaguin and Landau [49] and Verwey and Overbeek (DLVO theory) [50], the rate of aggregation is proportional to the term exp (−V_{T}/k_{B}T), where V_{T} represents the free energy of interaction, k_{B} is Boltzmann's constant and T is the absolute temperature. In case of the MWCNT/polyvinyl acetate composite film, the polyvinyl acetate particles began to form sediment almost immediately (V_{T}<<k_{B}T), which means that it is not in colloidal stability. This phenomenon is represented by its composite film structure. In other words, due to the high sinking speed of the polymer particles, a polymer layer is first formed and then the MWCNTs settled onto this polymer layer, resulting in the porous composite film shown in FIGS. 23a and 23b. In the case of the MWCNT/PVA and MWCNT/PEO composite films, both the polymer particles and the MWCNTs were in colloidal stability, and thus nonporous composite films were obtained (see FIG. 25 and FIG. 28).

Generally, percolation threshold can be calculated by two main methods: (i) percolation theory based models, which includes the Monte Carlo simulation and the excluded volume method, and (ii) non-percolation theory based models [51]. The percolation can be defined as e.g., a certain volume fraction of conductive filler inducing a sudden jump of conductivity of the composite. This sudden increase of conductivity is the main characteristic of percolation. Percolation theory based models show good agreement with experimental results. While the non-percolation based theories, which have been developed independently, were not successful relative to the percolation-based method [51].

The percolation-based theory (excluded volume method) was tried to calculate percolation threshold. As used herein, excluded volume is defined as the volume around an object in which the center of another object of identical shape is not allowed to penetrate [52, 53] and total excluded volume is obtained by multiplying N_{c} (critical concentration) to the excluded volume. In the 3D case, the percolation threshold (Φ_{c}) can be calculated by the equation given in [52]

$${Φ}_{c} = 1 - exp ( - \frac{< {V}_{ex} > V}{< {V}_{e} >} ) \qquad [ 2 ]$$

where <Vₑₓ> is the total excluded volume of an object in a given volume, V is the volume of an object and <Vₑ> is the average excluded volume of an object. To take advantage of this scheme, the MWCNT is modeled as capped cylinder of radius r and length l. The volume of this cylinder is given as:

$${V}_{cyl} = \frac{4}{3} π {r}^{3} + π {r}^{2} l \qquad [ 3 ]$$

<Vₑ> of isotropic (randomly distributed) capped cylinder system can be calculated [53, 54, 55] by:

$$< {V}_{e} >= \frac{32}{3} π {r}^{3} + 8 π {r}^{2} l + 4 {l}^{2} r < sin γ {>}_{μ} \qquad [ 4 ]$$

where <sin γ>_{μ} is an average of sin γ and π/4 is for an isotropic system. Thus, Eq. (3.4) can be written as

$$< {V}_{e} >= \frac{32}{3} π {r}^{3} + 8 π {r}^{2} l + \frac{π}{2} {rl}^{2} \qquad [ 5 ]$$

The universal value of <Vₑₓ> for the onset of percolation in a continuum is generated by the Monte Carlo simulation for an identical object system [56]. If universal values of <Vₑₓ> are used for a capped cylinder: 1.4 for randomly distributed, and 2.8 for objects in parallel, then the upper and lower limit of the percolation threshold can be found by the following double inequality via combining Eqs. (3.2), (3.3) and (3.5)

$$1 - exp ( - \frac{1.4 {V}_{cyl}}{< {V}_{e} >} ) \leq {Φ}_{c} \leq 1 - exp ( - \frac{2.8 {V}_{cyl}}{< {V}_{e} >} ) \qquad [ 6 ]$$

The excluded volume method was successfully applied to explain the percolation threshold change of various objects in micro-scale [57]. Based on the specification of the MWCNT (length 1-5 μm; diameter 15±5 nm), the percolation threshold of this research was calculated and was in the range of 0.14%≦Φ_{c}≦2.59%.

One of the non-percolation based theories was used to calculate percolation threshold. Percolation threshold (Φ_{c}) can also be calculated by an equation derived by Helsing and Helte [58] using average field approximation (AFA). This is one of the effective medium theory (EMT) [59] methods. In this method, the average effect of randomly distributed inclusions inside a matrix was calculated by treating a whole composite sample as a homogeneous effective medium. From the equation of ref. [58], if inclusions are assumed in the shape of ellipsoids (long and thin oblate), the percolation threshold (φ_{c}) is represented as Equation (7), where length of one major axis is R and two minor axes εR (ε<<1):

Φ_{c}=1.18ε [7]

From the specification of the MWCNT (length 1-5 μm; diameter 15±5 nm), percolation threshold lies between (Φ_{c,min}=0.236% and (Φ_{c,max}=2.36%. Predictions of Φ_{c} from both models are summarized in Table 3. The experimental percolation threshold of MWCNT/polymer composites film are determined and compared with theoretical values.

TABLE 3
Theoretical Calculation of Percolation Threshold

| | Predicted Percolation |
|---|---|
| Theoretical Model | Threshold (Φ_{c}) |
| Excluded Volume Method | 0.14% ≦ Φ_{c} ≦ 2.59% |
| Average Field Approximation Model | 0.24% ≦ Φ_{c} ≦ 2.36% |

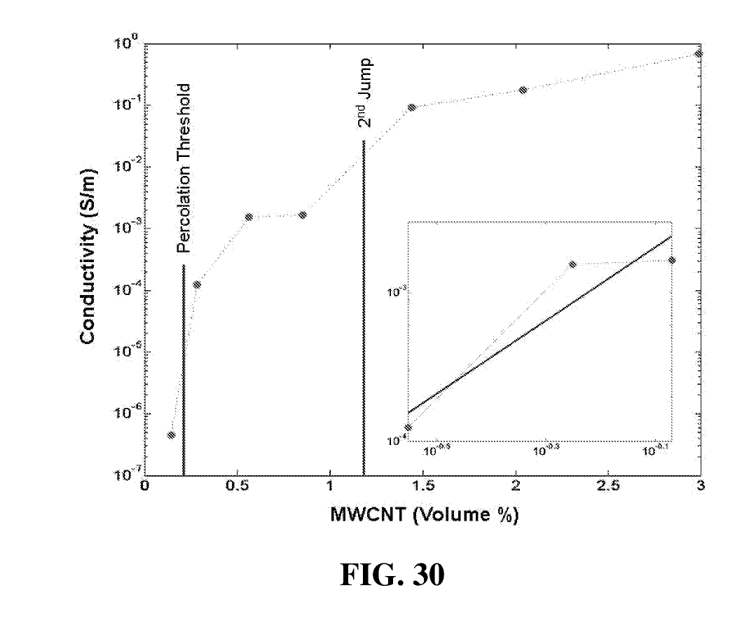

The electrical conductivity of the MWCNT/PEO was measured for a range of the MWCNT loading. The results of two point DC resistance measurements of the MWCNT/PEO composite films with different loading of the MWCNT were converted into conductivity. The conductivity change as a function of the volume fraction of the MWCNT is plotted in FIG. 30. The first finite value of measured conductivity is 4.52×10⁻⁷ S/m. Conductivity then increases as the loading of the MWCNT increases. The percolation threshold was observed to be between 0.14 and 0.28 vol. % of MWCNT (see FIG. 30). It was reported in the literature that the transition from nonconductive to conductive composite films is between 0.05 and 10 wt % depending on the polymer and processing technology, as well as the type of nanotubes used [61-66]. According to this specific embodiment, the experimentally determined percolation threshold value is very close to the lower limit of the excluded volume method model prediction (see Table 3) and thus, the MWCNTs inside the matrix can be considered to be randomly distributed (isotropic). As such, the present exemplary methods take full advantage of the used MWCNTs because the percolation threshold is directly related to the geometry of used MWCNTs.

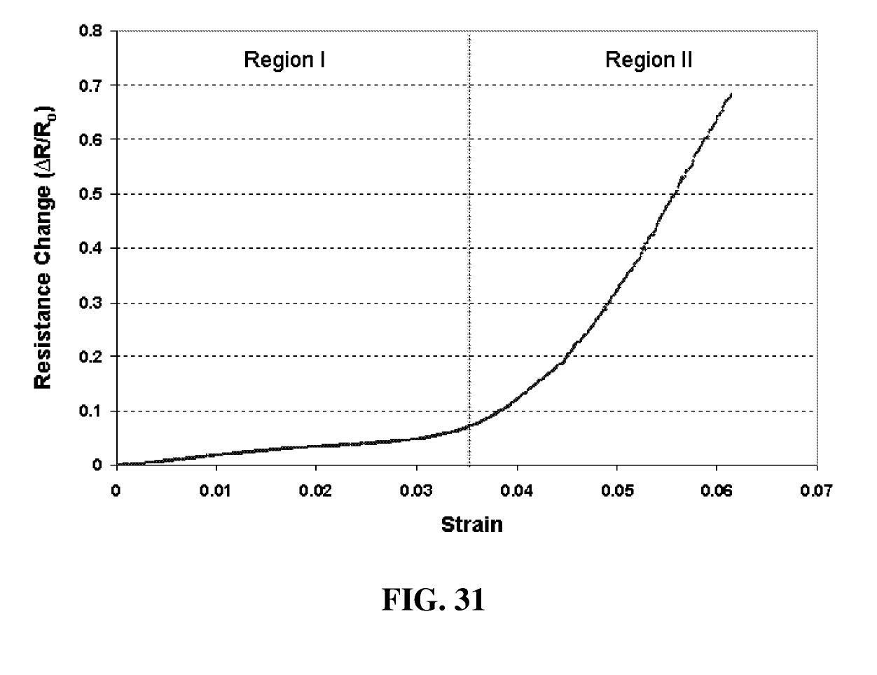

Resistance change as a function of strain is plotted in FIG. 31. Strain sensitivity is one of the important factors for strain sensing materials and is defined [71] as

$$S = \frac{Δ R / {R}_{o}}{ɛ} \qquad [ 8 ]$$

where S is the strain sensitivity, ΔR is the change in resistance, Rₒ is the initial resistance, and ε is strain. Based upon the observed strain sensitivity, the plot can be divided into two different regions at ε=0.035. These regions are marked as “Region I” and “Region II”. The strain sensitivity is obtained by linear curve fit for each region and found to be 1.63 for region I and 23.47 for region II. Compared with other researcher's works [69, 72-74], which investigated strains up to 0.04, the present MWCNT/PEO composite films can be used in a wider stain range (>20.06).

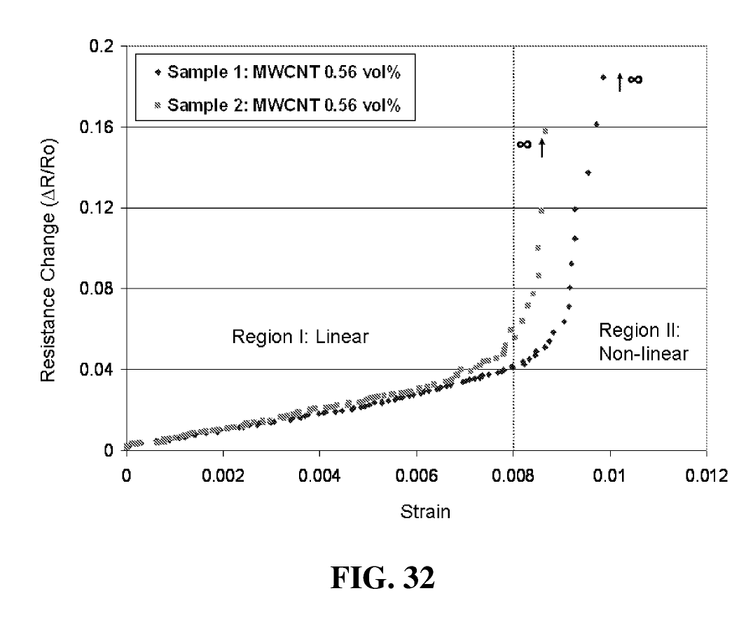

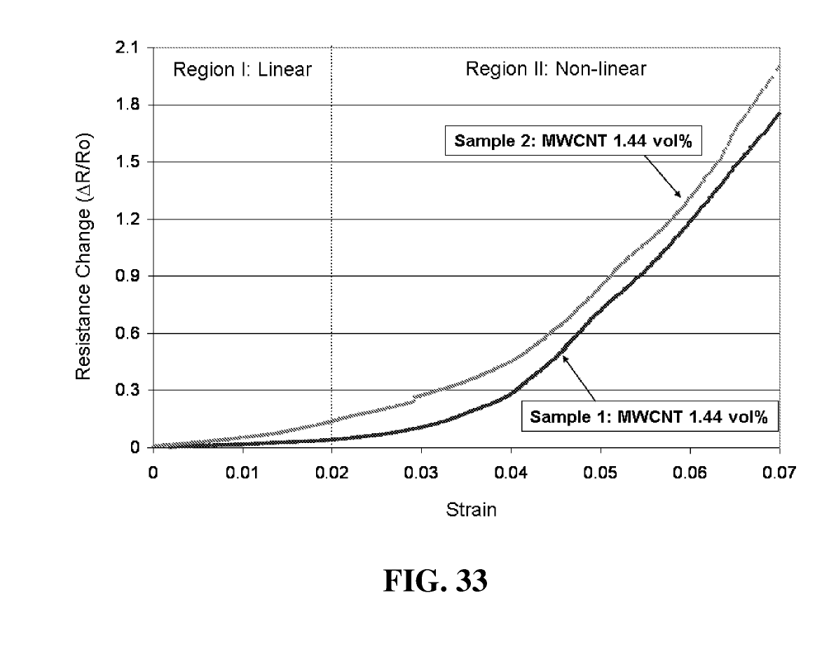

FIG. 32 (MWCNT 2 wt %) and FIG. 33 (MWCNT 5 wt %) show the resistance change mode with respect to strain change. The initial electrical resistances (i.e., no externally applied strain) were 598 and 493 kΩ for the two specimens having 0.56 vol % (=2 wt %) of MWCNT, and 6.89 and 6.29 kΩ for the specimens having 1.44 vol % (=5 wt %) of MWCNT. To compare the relationship between electrical resistance versus strain, the change in electrical resistance ΔR/Rₒ is plotted against strain in FIGS. 32 and 33 where ΔR is the difference between the current resistance (R) and initial resistance (Rₒ). For the MWCNT 0.56 vol % films (see FIG. 32), the electrical resistance increased in a linear and monotonic manner up to 0.008 strain, and then transitioned to a non-linear behavior; rapidly increasing in electrical resistance just before 0.009 strain. For the MWCNT 1.44 vol % films (see FIG. 33), electrical resistance increased linearly over a larger strain range (0.01 to 0.02) compared to the MWCNT 0.56 vol % case. After 0.02 strain, the relationship between electrical resistance and strain became non-linear. The measurements for the 1.44 vol. % films were stopped due to the onset of the localized necking of the polycarbonate substrate at about 0.07 strain. The relationship between electrical resistance and strain can be divided into a linear and non-linear region for both the 0.56 and 1.44 vol. % cases, as indicated in FIGS. 32 and 33. The linear and non-linear region was more distinctive for MWCNT 0.56 vol. % specimens compared with the 1.44 vol. % specimens. However, the overall pattern of electrical resistance change versus strain for the specimens of each volume fraction of MWCNT was found to be quite repeatable.

In the case of the MWCNT 2 wt % sample, resistance was monotonically increased and then showed a sudden jump in resistance around 0.009 strain. Thus, useful strain range can be up to 0.012 strain. This composite film (MWCNT 2 wt %) can be used as a switch. The resistance change mode was then repeated. For the MWCNT 5 wt % sample case, resistance changed smoothly, having a strain range up to 0.07. Therefore, this can be used as a wide range strain sensor. The resistance change mode also was repeated. Resistance change induced by deformation (strain) was highly dependent upon microstructure and mechanical properties. These exemplary films can be pre-stretched to some amount and bonded onto the structure surface. According to these exemplary embodiments, the film can be made more sensitive to external strain—i.e., the strain sensitivity of the fabricated film can be increased dramatically by using pre-stretched composite film. Moreover, due to the low melting and glass transition temperatures of the exemplary MWCNT/PEO composite films, the composite films can remain ductile at very low temperatures (e.g., near liquid nitrogen). As such, the composite films have a potential usage as strain sensors in extremely cold environments.

Mathematical models will be developed to simulate the experimentally measured deformation dependent electrical resistivity of the MWCNT/polymer composites film. Among many characteristics observed during the experiments using the MWCNTs, electrical resistance change of the MWCNT layer between copper plates was modeled by H. Kim [60]. Its derivation is described below. A model for calculation of thickness of the MWCNT/PEO composite film was developed and is also summarized below. Finally, a model will be developed to describe the results of electro-mechanical experiments using the MWCNT/polymer composite film, and particularly, the relationship between resistance change and deformation of the MWCNT/polymer composite is of interest.

A model was developed by H. Kim [61] and presented to predict the change in contact resistance as a function of applied compressive force, as plotted in FIG. 10. This model is based on resistance reduction due to the compaction of the MWCNT layer beneath a probe tip of area A (0.31 mm²). The volume of the MWCNTs beneath the probe has an initial volume fraction vₒ. During the probe's downward stroke, the volume fraction v is assumed to be related to strain as:

$$\frac{v}{{v}_{o}} = ( 1 + ɛ ) \qquad [ 9 ]$$

where ε is true strain, defined as positive in compression. Compressive force F is observed to be linearly related to downward probe movement (see FIG. 2.8) over a roughly 8-9 μm stroke. This linear behavior can be represented as:

F=E_{eff}Aε [10]

where E_{eff} is the effective elastic modulus of the MWCNT layer which can be found by the relationship:

$${E}_{eff} = \frac{L}{A} k \qquad [ 11 ]$$

where k is the experimentally measured stiffness in FIG. 9 during downward probe movement and L is chosen as 8 μm. Based on Eq. (11), E_{eff} is found to range from 3.2 to 4.5 MPa. A relationship between electrical conductance C and volume fraction is assumed to be in the form of a power law of order n, such that as the volume fraction of the MWCNT increases, the conductivity also increases beyond the starting value Cₒ corresponding to the initial volume fraction vₒ:

$$C = {{C}_{o} ( \frac{v}{{v}_{o}} )}^{n} \qquad [ 12 ]$$

Resistance is the inverse of C and can be expressed as:

$$R = {{R}_{o} ( \frac{v}{{v}_{o}} )}^{- n} \qquad [ 13 ]$$

Finally, Eqs. (9) to (11) can be combined into Eq. (14), resulting in a relationship between contact resistance R and probe compressive force.

$$R = {{R}_{o} ( 1 + \frac{F}{{E}_{eff} A} )}^{- n} \qquad [ 14 ]$$

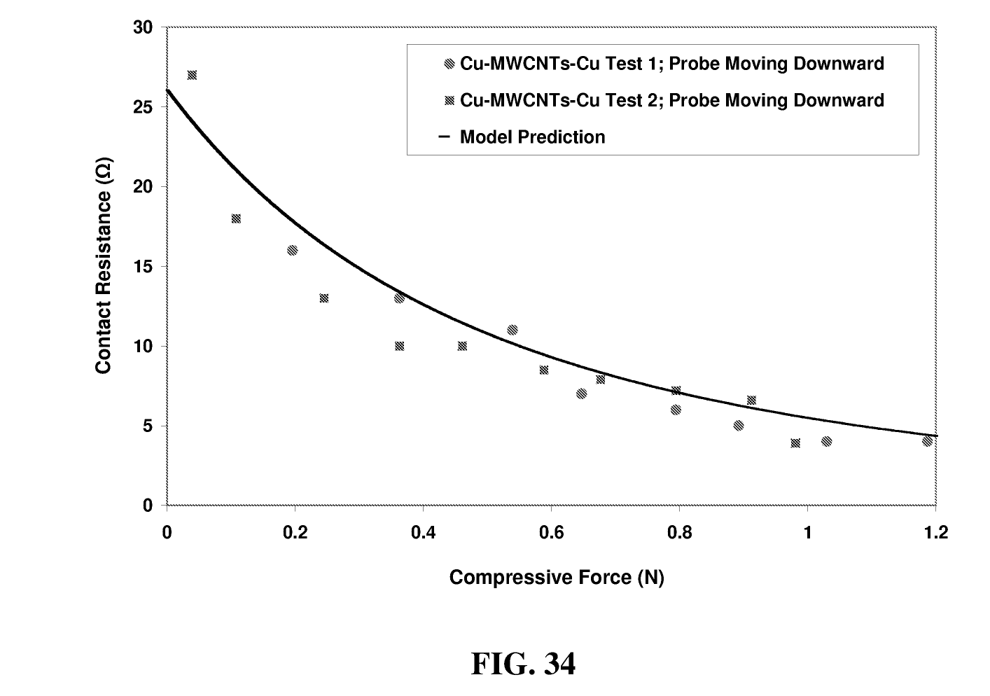

Parameters Rₒ and n in Eq. (14) are fitting constants that must be chosen to best match the resistance versus force data in 10. As shown in FIG. 34, choices of Rₒ=26.1Ω and n=2.87 are found to give a best fit to the pooled data (Tests 1 and 2 downward stroke).

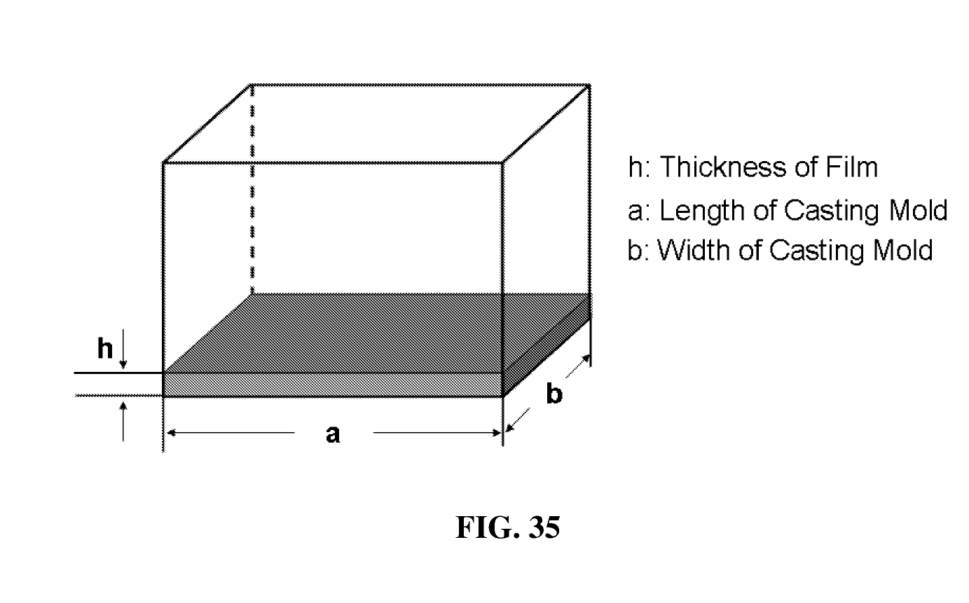

The thickness of MWCNT/polymer composite film is dependent upon the dimensions of the casting mold and the loading of the MWCNTs and polymer. Thickness control is very important in manufacturing consistent films. Thus, the relationship between thickness of the MWCNT/polymer composite and manufacturing parameters (amounts of raw materials and casting mold dimensions) are derived. It is assumed that the MWCNT and polymer are in colloid stability during processing and form a non-porous MWCNT/polymer composite film. In FIG. 35, the MWCNT/polymer composite film formed by the evaporation based in situ polymerization method on the bottom of the casting mold is depicted. The total volume of the MWCNT/polymer composite film is calculated from the geometry of casting film and the film thickness, wherein:

Vₘₚ=hab [15]

On the other hand, if mass m_{c} of the MWCNT with density ρ_{c}, mass mₚ of polymer with density ρₚ, and mass mₛ of SDS with density ρₛ are used, the total volume of the MWCNT/polymer composite also can be calculated as

$${V}_{tot} = \frac{{m}_{c}}{{ρ}_{c}} + \frac{{m}_{p}}{{ρ}_{p}} + \frac{{m}_{s}}{{ρ}_{s}} \qquad [ 16 ]$$

When Eqs. (15) and (16) are equal, then the thickness of the MWCNT/polymer composite can be calculated as

$$h = \frac{1}{ab} ( \frac{{m}_{c}}{{ρ}_{c}} + \frac{{m}_{p}}{{ρ}_{p}} + \frac{{m}_{s}}{{ρ}_{s}} ) \qquad [ 17 ]$$

From Eq. (17), the final thickness can be easily predicted, i.e., the MWCNT/polymer composite film can be made thicker if a smaller plan form area casting mold is used. The actual film thickness of three different samples and the predicted values using Eq. (17) were compared. It was found that the values of Eq. (17) were much higher than those of the actual film thicknesses due to the loss of material during processing—for example, the PEO and the MWCNT left on the surface of the mold and mixing beakers. Thus, Eq. (17) was modified as follows:

$$h = \frac{1}{ab} ( \frac{{m}_{c} - {m}_{cl}}{{ρ}_{c}} + \frac{{m}_{p} - {m}_{pl}}{{ρ}_{p}} + \frac{{m}_{s} - {m}_{sl}}{{ρ}_{s}} ) \qquad [ 18 ]$$

where m_{cl} is the loss of MWCNT, mₚₗ is the loss of polymer, mₛₗ is the loss of SDS. The total loss (mₜₒₜₗ) of raw material can be obtained by subtracting the final mass of the film from the total mass of input material. Here only the loss of polymer (mₜₒₜₗ□mₚₗ) was considered due to the relatively small amount of the MWCNT and the SDS. It is noted that ρₚ is the experimentally determined bulk density, and ρ_{c} and ρₛ are provided by the company.

$$h ≅ \frac{1}{ab} ( \frac{{m}_{c}}{{ρ}_{c}} + \frac{{m}_{p} - {m}_{totl}}{{ρ}_{p}} + \frac{{m}_{s}}{{ρ}_{s}} ) \qquad [ 19 ]$$

Model predictions and measured average film thickness are summarized in Table 4. The model prediction is a little higher than actual film thickness, but it is reasonably close to actual film thickness.

TABLE 4
Film Thickness -Model Prediction and Measured Value

| | | Measured Average | |
|---|---|---|---|
| | Model Prediction (mm) | Thickness (mm) | % Error |
| Sample A | 0.29 | 0.27 | +7.4 |
| Sample B | 0.29 | 0.29 | 0 |
| Sample C | 0.37 | 0.35 | +5.7 |

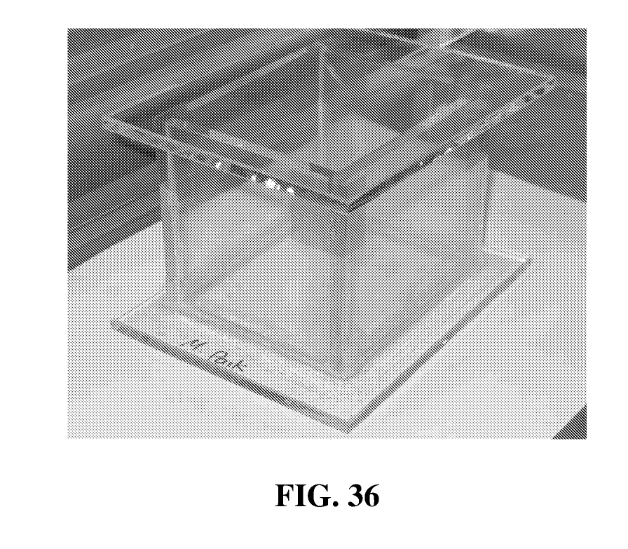

FIG. 36 depicts a photo of an exemplary casting frame in accordance with the present teachings. On the bottom surface of the casting frame, MWCNT/polymer composite film can be left or deposited from the fabrication process. Moreover, the dimension and shape of the composite film can be dictated by the overall shape of the casting frame.

In accordance with the present teachings, it was demonstrated that a MWCNT layer between Cu—Cu surfaces reduces electrical contact resistance by 80%. The possible mechanism for this reduction was analyzed and suggested. The MWCNT-enhanced surface showed a finite slope of electrical resistance as a function of contact force, thereby making possible the use of this arrangement as a small-scale force or pressure sensor. The MWCNT layer was shown that it is not only effective to reduce electrical contact resistance but also possible to be acted as a pressure sensor. However, there is limitation on the direct use of as-grown MWCNT on copper substrates due to the easy separation of the MWCNTs from the copper surface. Additionally, the growth of a MWCNT layer on different target substrates by PECVD process is not realistic due to the complexity of sample preparation and high cost.

To overcome these limitations, fabrication of MWCNT/polymer composite film was achieved via solution mixing and evaporation casting. Three different polymers were tried and PEO was found to be suitable for the chosen process parameters through the results of resistivity measurement and microstructure analysis. This process was found to be simple and effective to fabricate MWCNT filled polymer films and a model was developed to predict the final thickness of the film. Fabrication of conductive MWCNT/polymer composite film is important and this can be done by using an amount of MWCNT above percolation threshold. In addition, it is a necessary quantity for many models predicting resistivity of composites [51]. A series of specimens with different loadings of MWCNT were fabricated and its electrical resistance measured by a precision multimeter (Keithley 2000). Thus, percolation threshold was determined experimentally. Also, the obtained resistivity was repeatable and similar for the samples with the same loadings of MWCNT.

From strain sensing test, strain dependent electrical resistance change was observed. Repeatable relationship between resistance change and strain (MWCNT 2 wt % and MWCNT 5 wt % cases) was obtained within a reasonable strain range. Different loadings of MWCNT showed different resistance change relationships. Thus tunable strain sensor can be fabricated.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCES

The following are incorporated herein by reference in their entirety:
[1] Sumio Iijima, Helical microtube of graphitic carbon, Nature Vol. 354, pp. 56-58, 1991.
[2] Mauricio Terrones, Science and Technology of the Twenty-First Century: Synthesis, Properties and Application of Carbon Nanotubes, Annual Review of Materials Research, Vol. 33, pp. 419-501, 2003.
[3] H. Dai, E. W. Wong, C. M. Lieber, Probing Electrical Transport in Nanomaterials: Conductivity of Individual Carbon Nanotubes, Science, Vol. 272, pp. 523-526, 1996.
[4] T. W. Ebbesen, H. J. Lezec, H. Hiura, J. W. Bennett, H. F. Ghaemi and T. Thio, Electrical conductivity of individual carbon nanotubes, Nature Vol. 382, pp. 54-56, 1996.
[5] B. Q. Wei, R. Vajtai, and P. M. Ajayan, Reliability and current carrying capacity of carbon nanotube, Applied Physics Letters, Vol. 79, pp. 1172-1174, 2001.
[6] M. M. J. Treacy, T. W. Ebbesen and J. M. Gibson, Exceptionally high Young's modulus observed for individual carbon nanotubes, Nature Vol. 381, pp. 678-680, 1996.
[7] O. Lourie and H. D. Wagner, Evaluation of young's modulus of carbon nanotubes by micro-raman spectroscopy, Journal of Materials Research., Vol. 13, pp. 2418-2422, 1998.
[8] M. F. Yu, S. B. S. Files, S. Arepalli, and R. S. Ruoff, Tensile loading of ropes of single wall carbon nanotubes and their mechanical properties, Physical Review Letters, Vol. 84, pp. 5552-5555, 2000.
[9] M. F. Yu, O. Lourie, M. J. Dyer, K. Moloni, T. F. Kelly, and R. S. Ruoff, Strength and breaking mechanism of multiwalled carbon nanotubes under tensile load, Science, Vol. 287, pp. 637-640, 2000.
[10] J. Hone, M. Whitney, and A. Zettl, Thermal conductivity of single-walled carbon nanotubes, Synthetic Metals, Vol. 103, 2498-2499, 1999.
[11] Motoo Fujii, Xing Zhang, Huaqing Xie, Hiroki Ago, Koji Takahashi, Tatsuya Ikuta, Hidekazu Abe, and Tetsuo Shimizu, Measuring the Thermal Conductivity of a Single Carbon Nanotube, Physical Review Letters, Vol. 95, pp. 065502-1-065502-4, 2005.
[12] Wei Zhang, Zhiyuan Zhu, Feng Wang, Tingtai Wang, Litao Sun, and Zhenxia Wang, Chirality dependence of the thermal conductivity of carbon nanotubes, Nanotechnology, Vol. 15, pp. 936-939, 2004.
[13] Elton Daniel Graugnard, The Electronic Properties of Multi-Walled Carbon Nanotubes, Ph.D. Thesis, Purdue University, pp. 53-64, 2000.
[14] Jun Xu, Timothy S. Fisher, Thermal Contact Conductance Enhancement with Carbon Nanotube Array, Proceedings of IMECE 2004, ASME international Mechanical Engineering Congress and RD&D Expo., pp. 1-5, 2004.
[15] Tao Tong, Yang Zhao, Lance Delzeit, Arun Majumdar, and Ali Kashani, Multiwalled Carbon Nanotube/Nanofiber Arrays As Conductive And Dry Adhesive Interface Materials, Proceedings of Nano 2004, ASME Integrated Nanosystems, pp. 1-6, 2004.
[16] William F. Smith, Structure and properties of engineering alloys, 2^{nd} Edition, McGraw-Hill, pp. 233-243. 1993.
[17] L. You, W. T. Chang and M. Tabib-Azar, Selective Growth of Carbon Nanotubes by Catalyst Poisoning, Annual APS March meeting 2004, Montreal, Quebec, Cananda, 2004.
[18] A. M. Cassell, N. R. Franklin, T. W. Tombler, E. M. Chan, J. Han, H. Dai, Directed Growth of Free-Standing Single-walled Carbon Nanotubes, Journal of the American Chemical Society, Vol. 121, pp. 7975-7976. 1999.
[19] T. Kato, G. H. Jeong, T. Hirata, R. Hatakeyama, Structure control of carbon nanotubes using radio-frequency plasma enhanced chemical vapor deposition, Thin Solid Films Vol. 457, pp. 2-6, 2004.
[20] G. W. Ho, A. T. S. Wee, J. Lin, W. C. Tjiu, Synthesis of well-aligned multiwalled carbon nanotubes on Ni catalyst using radio frequency plasma-enhanced chemical vapor deposition, Thin Solid Films Vol. 388, pp. 73-77, 2001.
[21] G. Pfeiffer, S. Fetheroff, and S. S. Iyer, Final Polish For SOI Wafers—Surface Roughness And TTV Degradation, Proceedings 1995 IEEE International SOI Conference, pp. 172-173, October, 1995.
[22] Ragnar Holm, Electric Contacts, Springer-Verlag, New York, pp. 7-52, 1967.
[23] M. S. Fuhrer, J. Nygard, L Shih, M. Forero, Young-Gui Yoon, M. S. C Mazzoni Hyoung Joon Choi, Jisoon Ihm, Steven G. Louie, A. Zettl, Paul L. McEuen, Crossed Nanotube Junctions, Science Vol. 288, pp. 494-497, 2000.
[24] Alper Buldum and Jian Ping Lu, Contact resistance between carbon nanotubes, Physical Review B, Vol. 63, 161403 (R), pp. 161403-1-161403-3, 2001.
[25] S. N. Song, X. K. Wang, R. P. H. Chang, and J. B. Ketterson, Electronic Properties of Graphitic Nanotubles from Galvanomagnetic Effects, Physical Review Letters, Vol. 72(5), pp. 697-700, 1994.
[26] William D. Callister, Jr., Materials Science and Engineering An Introduction, 4^{th} Edition, pp. 389-390, 1997.
[27] Prasad Dharap, Zhiling Li, Satish Nagarajaiah and E V Barrera, Nanotube Film base on single-wall carbon nanotubes for strain sensing, Nanotechnology, Vol. 15, pp. 379-382, 2004.
[28] Mainalk Majumder, Nitin Chopra, Rodney Andrews, Bruce J. Hinds, Enhanced Flow in carbon nanotubes, Brief Communications, Nature, Vol. 438, p. 44, 2005.
[29] Carlos Velasco-Santos, Ana L. Martinez-Hernandez, Frank T. Fisher, Rodney Ruoff, and Victor M. Castano, Improvement of Thermal and Mechanical Properties of Carbon Nanotube Composites through Chemical Functionalization, Chemistry of Materials, Vol. 15, 4470-4475, 2003.
[30] Zhuangchun Wu, Zhihong Chen, Xu Du, Jonathan M. Logan, Jennifer Sippel, Maria Nikolou, Katalin Kamaras, John R. Reynolds, David B. Tanner, Arthur F. Hebard, Andrew G. Rinzler, Transparent, Conductive Carbon Nanotube Films, Science, Vol. 305, pp. 1273-1276, 2004.
[31] Jun Xu, Timothy S. Fisher, Thermal Contact Conductance Enhancement with Carbon Nanotube Array, Proceedings of IMECE 2004, ASME international Mechanical Engineering Congress and RD&D Expo., pp. 1-5, 2004.
[32] Tao Tong, Yang Zhao, Lance Delzeit, Arun Majumdar, and Ali Kashani, Multiwalled Carbon Nanotube/Nanofiber Arrays As Conductive And Dry Adhesive Interface Materials, Proceedings of Nano 2004, ASME Integrated Nanosystems, pp. 1-6, 2004.
[33] Merrill, M., C. T. Sun. Development of a Self-Assembly Method for Manufacturing Nanocomposites with High Loadings of Nanoparticles, Proceedings of the American Society for Composites Twentieth Technical Conference, Paper 153, pp. 1-13, 2005.
[34] Limin Huang, Xiaodong Cui, Gordana Dukovic and Stephen P O'Brien, Self-organizing high-density single-walled carbon nanotube arrays from surfactant suspensions, Nanotechnology, Vol. 15, pp. 1450-1454, 2004.
[35] Otto Z. Zhou, Soojin Oh, Jian Zhang, Yuan Cheng, Hideo Shimoda, Methods and Apparatus for Patterned Deposition of Nanostructure-Containing Materials by Self-Assembly and Related Articles, U.S. Pat. No. 6,969,690.
[36] R. E. Dillon, L. A. Matheson, E. B. Bradford, Sintering of Synthetic Latex Particles, Journal of Colloid and Interface Science, Vol. 6, pp. 108-117, 1951.
[37] D. P. Sheetz, Formation of Films by Drying of Latex, Journal of Applied Polymer Science, Vol. 9, pp. 3759-3765, 1965.
[38] F. Dobler, T. Pith, M Lambla, Coalescence Mechanisms of Polymer Colloids I. Coalescence under the Influence of Particle-Water Interfacial Tension, Journal of Colloid and Interface Science, Vol. 152, pp. 1-11, 1992.
[39] F. Dobler, T. Pith, M Lambla, Coalescence Mechanisms of Polymer Colloids, II. Coalescence with Evaporation, Journal of Colloid and Interface Science, Vol. 152, pp. 12-21, 1992.
[40] Fangming Du, John E. Fischer, Karen I. Winey, Coagulation Method for Preparing Single-Walled Carbon Nanotube/Poly(methyl methacrylate) Composites and Their Modulus, Electrical Conductivity, and Thermal Stability, Journal of Polymer Science, Vol. 41, pp. 3333-3338, 2003.
[41] Xiefei Zhang, Tao Liu, T. V. Sreekumar, Satish Kumar, Valerie C. Moore, Robert H. Hauge, and Richard E. Smalley, Poly(vinyl alcohol)/SWNT Composite Film, Nano Letters, Vol. 3, pp. 1285-1288, 2003.
[42] Milo S. P. Shaffer and Alan H. Windle, Fabrication and Characterization of Carbon Nanotube/Poly(vinyl alcohol) Compoistes, Advanced Materials, Vol. 11, pp. 937-941, 1999.
[43] Tohru Kimura, Hiroki Ago, Masayuki Tobita, Satoshi Ohshima, Mutsumasa Kyotani, and Motoo Yumura, Polymer Composites of Carbon Nanotubes Aligned by a Magnetic Field, Advanced Materials, Vol. 14, pp. 1380-1383, 2002.
[44] Jim Goodwin, Colloids and Interfaces with Surfactants and Polymers, Wiley, pp. 46-59, 2004.
[45] D. H. Everett, Basic Principles of Colloid Science, The Royal Society of Chemistry, pp. 153-166, 1988.
[46] James W Nilsson, Susan A. Riedel, Electric Circuits, 7th edition, Pearson Prentice Hall, pp. 70-83, 2005.
[47] Rizzoni, Principles and Applications of Electrical Engineering, IRWIN, pp. 27-28, 1993.
[48] Kunio Esumi, Polymer Interfaces and Emulsions, Marcel Dekker, pp. 128-132, 1999.
[49] E. J. W. Verwey and J. Th. G. Overbeek, Theory of the Stability of Lyophobic Colloids, Elsevier, Amsterdam, 1948.
[50] J. Th. G. Overbeek, Pure and Applied Chemistry, Vol. 52, pp. 1151-1161, 1980.
[51] M. Weber and M. R. Kamal, Estimation of the Volume Resistivity of Electrically Conductive Composites, Polymer Composites, Vol. 18, pp. 711-725, 1997.
[52] I. Balberg, Excluded-volume explanation of Archie's law, Physical Review B, Vol. 33, pp. 3618-3620, 1986.
[53] L. Onsager, The effects of shape on the interaction of colloidal particles, Annual New York Academy Science, Vol. 51, pp. 627-659, 1949.
[54] I. Balberg, N. Binenbaum and N. Wagner, Percolation thresholds in the three-dimensional sticks system, Physical Review Letters, Vol. 52, pp. 1465-1486, 1984.
[55] I. Balberg, C. H. Anderson, S. Alexander and N. Wagner, Excluded volume and its relation to the onset of percolation, Physical Review B, Vol. 30, pp. 3933-3943, 1984.
[56] I. Balberg, “Univeral” percolation-threshold limits in the continuum, Physical Review B, Vol. 31, pp. 4053-4055, 1985.
[57] A. Celzard, E. McRae, C. Deleuze, M. Dufort, G. Furdin, J. F. Mareche, Critical concentration in percolating systems containing a high-aspect-ratio filler, Physical Review B, Vol. 53, pp. 6209-6214, 1996.
[58] J. Helsing and A. Helte, Effective conductivity of aggregates of anisotropic grains, Journal of Applied Physics, Vol. 69, pp. 3583-3588, 1991.
[59] G. W Milton, The Coherent Potential Approximation is a Realizable Effective Medium Scheme, Communication in Mathematical Physics, Volume 99, pp. 463-500, 1985.
[60] Myounggu Park, Baratunde A. Cola, Thomas Siegmund, Jun Xu, Matthew R. Maschmann, Timothy S. Fisher, Hyonny Kim, Effects of a carbon nanotube layer on electrical contact resistance between copper substrate, Nanotechnology, Volume 17, pp. 2294-2303, 2006.
[61] J. K. W. Sandler, J. E. Kirk, I. A. Kinloch, M. S. P. Shaffer, A. H. Windle. 2003. “Ultra-low electrical percolation threshold in carbon-nanotube-epoxy composite”, Polymer 44: 5893-5899.
[62] B. E. Kilbride, J. N. Coleman, J. Fraysse, P. Fournet, M. Cadek, A. Drury, S. Hutzler, S. Roth, W. J. Blau. 2002. “Experimental observation of scaling laws for alternating current and direct current conductivity in polymer carbon nanotube composite thin films”, J Appl Phys 92(7): 4024-4030.
[63] P. C. P. Watts, W. K. Hsu, G. Z. Chen, D. J. Fray, H. W. Kroto, D. R. M. Walton. 2001. “A low resistance boron-doped carbon nanotube-polystyrene composite”, J Appl Polym Sci, 11(10): 2482-2488.
[64] B. Safai, R. Andrews, E. A. Grulke. 2002. “Multiwalled carbon nanotube polymer composites: synthesis and characterization of thin films”, J Appl Polym Sci, 84(14): 2660-2669.
[65] C. Stephan, T. P. Nguyen, B. Lahr, W. Blau, S. Lefrant, O. Chauvet. 2002. “Raman spectroscopy and conductivity measurements on polymer-multiwalled carbon nanotubes composites”, J Mater Res, 17(2): 396-400.
[66] Petra Potschke, Arup R. Bhattacharyya, Andreas Janke. 2004. “Melt mixing of polycarbonate with multiwalled carbon nanotubes: microscopic studies on the state of dispersion”, European Polymer Journal, 40: 137-148.
[67] Panagiotis Blanas and Dilip K. D-gupta. 1999. “Composite Piezoelectric Sensors for Smart Composite Structures” in 10^{th} International Symposium on Electrets, pp. 731-734.
[68] Amir Javidinejad and Shiv P Joshi. 1999. “Design and structural testing of smart composite structures with embedded conductive thermoplastic film”, Smart Mater. Struct. 8: 585-590.
[69] Prasad Dharap, Zhiling Li, Satish Nagarajaiah, and E. V. Barrera. 2004. “Nanotube film based on single-wall carbon nanotubes for strain sensing”, Nanotechnology, 15:379-382.
[70] Keithley, inc. 2004. “I-V Measurements of Nanoscale Wire and Tubes with the model 4200-SCS and Zyvex S100 Nanomanipulator”, Application Note Series, Number 2418.
[71] Allan R. Hambley. 2005. Electrical Engineering, Principles and Applications, 3^{rd} Edition, Pearson Education, Inc, p. 32.
[72] Xiaojun Wang and D. D. L. Chung. 1995. “Short-carbon-fiber-reinforced epoxy as a piezoresistive strain sensor”, Smart Mater. Struct., 4:363-367.
[73] Jonathan R. Wood and H. Daniel Wagner. 2000. “Single-wall carbon nanotubes as molecular pressure sensors”, Applied Physics Letters, 76(20): 2883-2885.
[74] Chun-Yu Li and Tsu-Wei Chou. 2004. “Strain and pressure sensing using single-walled carbon nanotubes”, Nanotechnology, 15:1493-1496.

What is claimed is:

1. A method for fabricating an electrically conductive composite structure, comprising:
forming a mixture including carbon nanotubes, a polymeric compound, surfactant and water;
introducing the mixture to a substrate; and
evaporating water from the mixture to form a composite film on the substrate.

2. The method of claim 1, wherein the carbon nanotube comprises multi-walled carbon nanotubes.

3. The method of claim 1, wherein the surfactant comprises sodium dodecyl sulfate.

4. The method of claim 1, wherein the polymeric compound is selected from at least one of water soluble polymer-like polyethylene oxide and polyvinyl alcohol.

5. The method of claim 1, wherein the substrate is selected from at least one of copper, a silicon wafer and a glass plate.

6. The method of claim 1, wherein the composite film has a percolation threshold value between about 0.14 and 0.28 vol. % of the carbon nanotubes.

7. The method of claim 1, wherein the composite film is adapted for use as a strain sensor device.

8. The method of claim 1, wherein the step of evaporating water from the mixture comprises subjecting the mixture to an evaporation casting procedure.

9. The method of claim 8, wherein the evaporation casting procedure is performed at a temperature of about 90° C.

10. The method of claim 1, wherein the step of introducing the mixture to a substrate comprises pouring the mixture into a casting frame having a surface coated with a release spray.

11. The method of claim 10, wherein forming a composite film on the substrate comprises depositing the composite film on a bottom surface of the casting frame.

12. The method of claim 1, wherein the step of introducing the mixture to a substrate comprises immersing at least a portion of the substrate in the mixture.

13. A method for fabricating an electrically conductive composite structure, comprising:
forming a first solution including multi-walled carbon nanotubes, surfactant and water;
forming a second solution including water and a polymeric compound selected from at least one of water soluble polymer-like polyethylene oxide and polyvinyl alcohol;
mixing the first and second solutions together to form a third solution;
introducing the third solution to a substrate; and
subjecting the third solution to an evaporation casting procedure, the evaporation casting procedure causing a composite film to remain on the substrate after the water evaporates from the third solution.

14. The method of claim 13, wherein the step of introducing the third solution to a substrate comprises pouring the third solution into a casting frame having a surface coated with a release spray.

15. The method of claim 14, wherein causing a composite film to remain on the substrate comprises depositing the composite film on a bottom surface of the casting frame.

16. The method of claim 13, wherein the step of introducing the third solution to a substrate comprises immersing at least a portion of the substrate in the third solution, wherein the substrate is selected from at least one of copper, a silicon wafer and a glass plate.

17. The method of claim 13, wherein the surfactant comprises sodium dodecyl sulfate.

18. The method of claim 13, wherein the composite film left on the substrate has a percolation threshold value between about 0.14 and 0.28 vol. % of the carbon nanotubes.

19. The method of claim 13, wherein the composite film is adapted for use as a strain sensor device.

20. The method of claim 13, wherein the step of mixing the first and second solutions together comprises subjecting the solutions to an ultrasonicator.

21. An electrically conductive composite film for use as a strain sensor formed by subjecting a substrate to an evaporation casting procedure, the substrate being immersed in a mixture during the evaporation casting procedure, wherein the mixture comprises carbon nanotubes, a polymeric compound, surfactant and water.

22. The composite film of claim 21, wherein the carbon nanotubes comprise multi-walled carbon nanotubes.

23. The composite film of claim 21, wherein the surfactant comprises sodium dodecyl sulfate.

24. The composite film of claim 21, wherein the polymeric compound is selected from at least one of water soluble polymer-like polyethylene oxide and polyvinyl alcohol.

25. The composite film of claim 21, wherein the substrate is selected from at least one of copper, a silicon wafer and a glass plate.

26. The composite film of claim 21, wherein the composite film has a percolation threshold value between about 0.14 and 0.28 vol. % of the carbon nanotubes.
